(19) United States
(12) Patent Application Publication
(10) Pub. No.: US 2017/0142017 A1
(43) Pub. Date: May 18, 2017

(54) A WLAN CONTROLLER

(71) Applicant: Dublin Institute of Technology, Dublin (IE)

(72) Inventor: Mark Davis, Co. Wicklow (IE)

(21) Appl. No.: 15/322,067

(22) PCT Filed: Jul. 3, 2015
(86) PCT No.: PCT/EP2015/065175

§ 371 Date: Dec. 23, 2016

(30) Foreign Application Priority Data
Jul. 3, 2014 (GB) 1411944.0

(51) Int. Cl. H04L 12/851; H04W 74/08; H04L 12/26

(52) U.S. Cl. CPC H04L 47/24; H04L 43/0882; H04W 74/08; H04W 84/12

(57) ABSTRACT

The present application is related to wireless networks and presents a method by which capacity on a wireless network may be measured. The capacity measurement may be employed to tune the EDCA settings of the wireless network.

### FIELD

The present application relates generally to wireless local area networks (WLAN) and more particularly to access control to such networks.

### BACKGROUND OF THE INVENTION

Wi-Fi™ is a popular technology that allows an electronic device to exchange data wirelessly over a computer network. Thus allowing a user to wirelessly connect with other devices in the network or through connections such as might be provided by a wireless router to external networks such as the Internet. The Wi-Fi Alliance defines Wi-Fi as any “wireless local area network (WLAN) products that are based on the Institute of Electrical and Electronics Engineers' (IEEE™) 802.11 standards”. However, since most modern WLANs are based on these standards, the term Wi-Fi is used in general English as a synonym for “WLAN”.

WLANs are commonly employed to establish networks in many industrial, office, home and medical environments. One of the reasons why WLANs are preferred over traditional wired LANs is the ease with which they may be set-up. The need for expensive cabling and trunking is eliminated and allows for users to move location within the WLAN's area of coverage or indeed into other connected WLANs area of coverage, which may extend thus to cover a geographical significant area including for example a public space or town center.

WLAN's are also commonly employed in public or semi-public areas to allow a person access to the Internet through a Wi-Fi access point. Typical examples of where such Wi-Fi access points might be provided are airports and other transportation hubs, campuses, malls, cafes, hotels, aircraft, ships, and trains and buses. In some situations, access to the access point may be controlled. For example, in certain situations, a user may require a paid subscription to access a given access point. Such access control may be operated on the basis on the MAC address of the device or the requirement for a username and password.

Whilst such access control may control which users may access the Internet through the access point, such control is largely limited to determining who can access. Once a user is granted access to the access point, they contend for the available wireless bandwidth equally with other users.

The IEEE 802.11 protocol includes a media access control (MAC) layer for coordinating access to the wireless medium. The basic IEEE 802.11 MAC layer uses a Distributed Coordination Function (DCF) to share the wireless medium between multiple stations in the WLAN. DCF relies on a carrier sense multiple access with collision avoidance (CSMA/CA) mechanism to share the medium between users.

The main limitation of the earlier Wi-Fi standards (IEEE 802.11b/a/g was that they generally could not support Quality of Service (QoS) differentiation among different types of traffic, i.e. with IEEE 802.11b every type of traffic is treated with equal fairness in accessing the network, i.e. that each station contending for access to transmit a packet has an equal probability of transmitting the packet. The downside of this is that at any particular instant, it does not consider the importance or urgency of the packet or indeed the size of the packet, thus whilst this fairness approach works well generally, it can have negative effects where the traffic is delay or throughput sensitive traffic such as real time voice or video communication.

In an effort to address this deficiency in the earlier IEEE 802.11 standards, a new standard called the IEEE 802.11e WMM has emerged which has prioritized traffic delivery by differentiating between different types of traffic and thus allows for QoS provisioning by granting different types of traffic different access. More specifically, the standard operates by allocating different MAC parameters to different service classes. For example, ftp traffic could be assigned to a low priority class, and VOIP (Voice over Internet Protocol) traffic could be assigned to a high priority class.

More particularly, the IEEE 802.11e WMM standard provides quality-of-service (QoS) functions to WLANs and defines priority control functions for IEEE 802.11 systems with an enhanced distributed coordination function in IEEE 802.11e EDCA (enhanced distributed channel access). In EDCA packets presented from the upper layer are classified\filtered into four access categories (ACs) according to their priority: best effort (AC_BE), background (AC_BK), video (AC_VI), and voice (AC_VO).

An Access Category Index (ACI) field is used in data frames to indicate the AC that transmitted the frame, as follows:

| Access Category | ACI |
|---|---|
| AC_BE | 0 |
| AC_BK | 1 |
| AC_VI | 2 |
| AC_VO | 3 |

The packets which are presented by higher network layers are generally classified based on the TOS (type of service) field of the IP header or the VLAN (virtual LAN) tag, which is defined in 802.1Q, although other “tagging” techniques may be employed. In the 802.11 system, in the MAC layer 4, each AC has its own set of EDCA access parameters, 16, 18, 20, 22 and they serve to determine the priority of the AC. After the classification, the packets are filtered and stored by an appropriate mechanism 6 into distinct queues 8, 10, 12, 14. Each queue represents a different AC (see FIG. 1). Then, each AC executes the carrier sense multiple access with collision avoidance (CSMA/CA) procedure 16, 18, 20, 22 with their own EDCA parameters, which is the basic procedure for transmitting a frame in an IEEE 802.11 WLAN, in order to resolve internal collisions between ACs. Thus whilst the possibility of external collision with other stations remains, internal collision between the ACs is handled by the internal collisions resolution mechanism and thus only one AC within a station [i.e. the station AC with the highest priority] competes with other stations at the L2/MAC Layer 4 for a transmission opportunity on the physical layer 2 at any one time.

The EDCA frame transmission scheme is based on CSMA/CA which in turn is directed for use with a transmission scheme referred to as distributed coordination function (DCF). In DCF, a wireless station (STA) with frames to transmit starts the carrier sense procedure and checks whether the channel is idle or busy. The STA starts to send the frame after waiting for a time equal to the sum of the distributed inter-frame space (DIFS) interval, which is a fixed waiting time, and the contention window if the channel is not busy during the DIFS time. In EDCA, these transmission procedures are done independently in each STA AC. The STA AC whose waiting time reaches zero sooner than those of other STA ACs gets the transmission opportunity. The contention window is calculated from the number of slots, which is chosen randomly between 0 and CWmin. The size of the contention window is defined based on two EDCA access parameters: CWmin and CWmax. The value of the CWmin parameter is used when the frame is transmitted for the first time. If the frame is retransmitted because of a collision or transmission error, the size of the contention window is increased (i.e. doubled) to reduce the probability of collision by extending the number of selectable slots. This is known as the exponential backoff mechanism. The contention window should not be bigger than the parameter value for CWmax defined as the maximum window size.

In EDCA, the STA AC uses an arbitration inter-frame space (AIFS) instead of DIFS as the fixed waiting time. While DIFS has a single waiting period, AIFS may have a different value for each STA AC, with higher-priority STA ACs having shorter AIFSs. Therefore, the higher-priority STA ACs are capable of winning more transmission opportunities than the lower-priority ones. Also, CWmin and CWmax are shorter for higher-priority STA ACs. Essentially the AIFS and CWmin parameters allow a STA AC to win a transmission opportunity quicker (i.e. in less time on average) than other STA ACs with larger AIFS and CWmin values. The shorter the time required by an AC to win a transmission opportunity means that the STA AC can transmit more frames in a unit of time which corresponds to a greater share of the available bandwidth, i.e. the capacity. The CWmax parameter imposes an upper limit on the size of CWmin which in turn imposes an upper limit on its time spent in winning a transmission opportunity. Once a transmission opportunity is won, the packet is transmitted by the Wireless, i.e. Physical or PHY, layer 2.

EDCA access parameters (AIFS, CWmin, CWmax, and TXOP) are set in each STA AC in advance (i.e. using default values). An AP that supports the IEEE 802.11e WMM standard and employs the EDCA mechanism is referred to generally as a QoS enabled AP (QAP).

A beacon management frame may be broadcast by the QAP that contains an EDCA parameter information field that informs the stations associated with the QAP what parameters they should use. A client STA that receives a beacon frame from the QAP that it is associated with, if it supports the IEEE 802.11e standard, is obliged to update its EDCA parameters and to use these updated EDCA parameters when contending for access. In this way, the QAP can control the EDCA parameters of the associated STAs that it is servicing.

Furthermore, the QAP is permitted to use its own set of EDCA access parameters that may be different from those of the client STAs that are associated with it. Thus, there are two sets of EDCA access parameters that are specified for an QAP, i.e. an internal set (sometimes referred to as the AP set) that it uses itself and an external set (sometimes referred to as the BSS set) that are used by its associated client STAs. Hence the operation of the QAP may be prioritized over that of its associated client STAs.

It is more common to express the contention window values CWmin and CWmax in an exponent form as follows:

CWmin=2^{ECWmin}−1

CWmax=2^{ECWmax}−1

Where 0≦ECWmin, ECWmax≦15 and where ECmax>ECmin

Similarly, the arbitration interframe space AIFS is expressed in terms of the SIFS and Tslot values pertinent to the PHY mechanism being used, as follows:

AIFS=SIFS+Tslot×AIFSN

Where SIFS is the short interframe spacing and Tₛₗₒₜ is the duration of a time slot. The value of these parameters is specified in the standard according to the PHY mechanism used.

The arbitration interframe space number AIFSN has valid values in the range
2≦AIFSN≦15 for client stations

and
1≦AIFSN≦15 for QAP stations

Consequently, the standard way to specify the EDCA parameters for an AC is in the following format (AIFSN, ECWmin, ECWmax). The default EDCA settings for IEEE 802.11b would be (2, 5, 10), while for IEEE 802.11a the default settings would be (2, 4, 10).

Although a QAP can control the priority of ACs using EDCA, the default EDCA parameters of IEEE 802.11e are not optimal for every situation. For example, the default CWmin and CWmax parameters are set to small values because higher-priority ACs should have shorter waiting times. However, it will be understood that shorter contention windows increase the probability of collision because they limit the randomly chosen slot number when the contention window is small. An increased probability of collision results in a larger average CW size owing to the exponential backoff mechanism. Accordingly, simply choosing the shortest waiting time doesn't necessarily mean that throughput is improved and depending on the number of stations present could result in a significant dis-improvement.

Even though the IEEE 802.11e standard provides for differentiation between service classes, typically the IEEE 802.11e parameters are static in nature, i.e. the parameters although changeable are in fact rarely changed from their initial (i.e. default) settings, with the result that performance is rarely optimal but instead varies under network conditions.

Conventionally, the approach adopted is that the person configuring a QAP initializes the QAP with MAC parameters for each type of traffic using their best estimate of appropriate values or indeed uses default values installed on the access point. Once configured, the default values are rarely changed. Thus when network conditions in the WLAN change, the IEEE 802.11e EDCA parameters do not adapt to those changing conditions resulting in sub-optimal performance.

A number of approaches have been proposed to address this, including for example as disclosed in US20090303908. US20090303908 discloses a system for setting WLAN STA operating (MAC) parameters, which involves measuring the QoS performance of each STA at the STA. To achieve this, each individual STA has a controller configured to provide individualized control of the MAC parameters based upon a QoS threshold that is a function of the MAC parameters. The controller is programmed to measure current settings for at least a portion of the MAC parameters for the STA, input the current settings for those MAC parameters of the STA into a WLAN system model to generate a system model output, and adapt a setting of at least one of the MAC parameters for the STA to meet the QoS threshold for the STA based on the system model output.

Each STA in the network makes adjustments locally to its EDCA parameters. As a result, this approach is only practical where you have complete control of each STA on a network. Otherwise, the network operates in an unfair mode where different STAs have different EDCA parameters for notionally the same QoS traffic and thus one STA may be favored over another. In the context of US20090303908, this is possible as it mentions deployment in a hospital type environment for linking medical equipment by WLAN where such an arrangement might be appropriate.

However, in the context of a typical WLAN, the network operator has generally no control over the devices connecting. Additionally, the method works from the perspective of the individual STA operating to meet its individual QoS requirements. It is generally more desirable that the network operate as a whole rather than an individual STA by STA basis. The present application proposes an alternative approach which does not require direct control of individual devices (i.e. STAs) in the WLAN network.

Another approach is that described in EP2685776-A1. This approach includes determining a bandwidth occupancy rate for each access category, and then dynamically changing parameters regarding the priority control for each category. The bandwidth occupancy rate is derived from the channel utilization field defined in the BSS Load element under the IEEE 802.11 standard. Channel utilization simply provides one with a measurement of how much bandwidth is being used.

### SUMMARY

The present application addresses the problems of the prior art. As an example, the approach adopted by EP2685776-A1 does not capture the contention based nature of the IEEE 802.11 MAC which is based upon a random access Carrier Sense Multiple Access with Collision Avoidance (CSMA/CA). Instead, the method in EP2685776 operates on the premise that a measurement of the bandwidth being consumed is reflective of how much bandwidth remains to be used. However, this approach does not provide any information on how efficiently the station is accessing the bandwidth of the medium and hence it cannot provide an indication of how close to saturation that the station is operating.

The present application adopts a different approach which determines a capacity utilization values for individual classes of traffic broadcasting on the wireless medium. In contrast, to the channel utilization value referenced above, the capacity utilization value does not simply represent how much bandwidth is being consumed but instead represents how close to saturation that class of traffic is on the medium. In other words, it considers the availability of bandwidth.

The present application is directed at deployment of a solution in a wireless device in proximity to the QAP or within the QAP itself rather than individually within each STA. This is so that the measurements employed by the solution reflect those experienced by the QAP. Ideally, the wireless device is placed as close as possible. The closer the measurement is made to the QAP, the better the accuracy of measurement. Typically, therefore the solution should be deployed suitably within 10 meters of the QAP to be managed. Preferably the deployment distance is less than 3 metres of the QAP. This is to ensure that the measurements of the wireless medium condition correspond as closely as possible to those experienced by the QAP. The solution operates to determine and change the EDCA settings in the QAP. These changes may be limited to the QAP's EDCA settings as this is where the network saturation/congestion is most likely to occur. The QAP is allowed to use its own EDCA settings (i.e. the AP set) which may be different from those used by the associated client STAs. They may also be applied to generate EDCA settings for the network so as to use the theoretical compliance with the Wi-Fi standard in which all the STAs associated with a QAP are required to adopt the EDCA settings as broadcast within beacon management frames (transmitted by the QAP) to optimize settings across the network. Consequently, all client STAs associated with the QAP may be directed to use the same set of EDCA (i.e. the BSS set) parameters.

The present application provides a system and method for setting a plurality of operating parameters for a WLAN such that QoS requirements are met. The operating parameters for the WLAN to meet the QoS requirements are determined by way of local measurements, acquired by a measurement STA, that are communicated to the WLAN. The measurement STA may be a standalone device or it may be provided within the QAP itself. Where, it is to be implemented in the QAP, it will be appreciated that the QAP must be capable of being modified to facilitate this. For example, this might generally require that the driver firmware and underlying hardware can support use of the monitor mode. Deployment within the QAP itself is the preferred solution as it ensures that the measurements of the medium condition correspond exactly to those experienced by the QAP in winning transmission opportunities for its traffic load.

The present application provides for a WLAN bandwidth controller system and method whereby local measurements of bandwidth usage and availability are used to adaptively adjust the EDCA settings of a QAP subject to user-specified targets for capacity utilization. The key aspect of this is the control element—the user specifies performance targets for each of the AC streams (i.e. in terms of a minimum availability of bandwidth) and then the WLAN bandwidth controller adjusts the EDCA values for each of the AC queues (according to a tuning algorithm) in order to achieve these targets.

The present application employs a model which is responsive to a series of passive measurements performed locally at a measurement STA. These measurements are employed to construct a model of the bandwidth usage and availability that corresponds as closely as possible to that experienced by the QAP in competing for transmission opportunities. The model considers both AIFSN and CWmin parameters.

Other features and advantages of the present application will become apparent from the detailed description and drawings which follow.

### BRIEF DESCRIPTION OF THE DRAWINGS

The present application will now be described with reference to the accompanying drawings in which:

FIG. 1 is an illustration of the IEEE 802.11e contention access process structure;

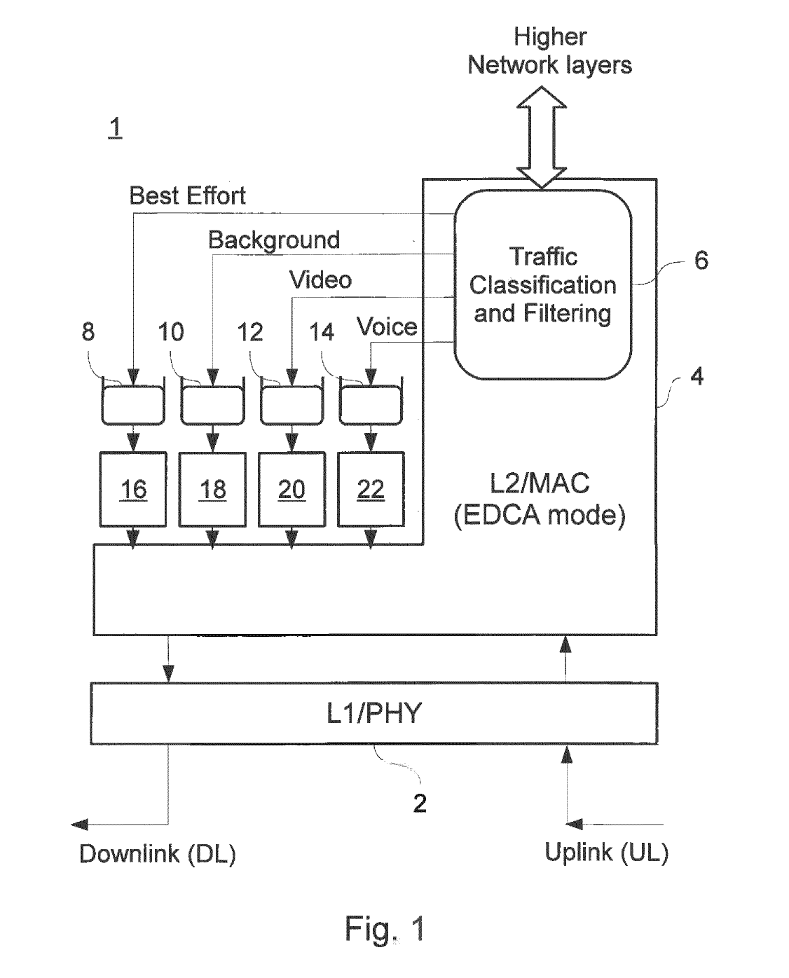

FIG. 2 is an exemplary WLAN architecture employing an arrangement of the present application;

FIG. 3 shows a series of packets to illustrate the nature of station contention;

FIG. 4 represents a method by which contention may be determined to be present or not according to aspect of the present application;

FIG. 5 illustrates an exemplary implementation employing two linked processes according to another aspect of the present application;

FIG. 6 illustrates an exemplary flowchart for a first of the processes of FIG. 5;

FIG. 7 illustrates an aspect of a step from the flowchart of FIG. 6;

FIG. 8 represents a further aspect from the flowchart of FIG. 6;

FIG. 9 represents yet a further aspect from the flowchart of FIG. 6;

FIG. 10 represents a data structure which may be employed to represent a list of stations in the process of FIG. 5;

FIG. 11 represents a list of access class settings;

FIG. 12 represents a process for updating the data structure of FIG. 10 and list of FIG. 11;

FIG. 13 illustrates the calculation of interframe interval times as employed in the method of FIG. 6;

FIG. 14 illustrates an exemplary method of determining a contention flag for the method of FIG. 6;

FIG. 15 illustrates an exemplary flowchart for contention estimation and MAC BW calculation;

FIG. 16 illustrates an exemplary Bayesian contention estimation process which may be used in the method of FIG. 15;

FIG. 17 is an exemplary tree data structure which may be employed in the method of FIG. 16;

FIG. 18 is an exemplary data structure which may be used for a node in the tree of FIG. 17;

FIG. 19 is an exemplary flowchart for retrieving average MAC contention parameters as employed by a step in the method of FIG. 15;

FIG. 20 is an exemplary flowchart of a step of updating the interval data as employed by the method of FIG. 15;

FIG. 21 is an exemplary flowchart of a step of calculating MAC BW components as employed by the method of FIG. 15;

FIG. 22 is an exemplary structure which might be used to store channel data;

FIG. 23 is an exemplary structure which might be used to store station data;

FIG. 24 is an exemplary structure which might be used to store station AC data;

FIG. 25 is an exemplary control algorithm which may be employed to adjust EDCA values in a WLAN, and

FIG. 26 is an exemplary handoff process using capacity measurement.

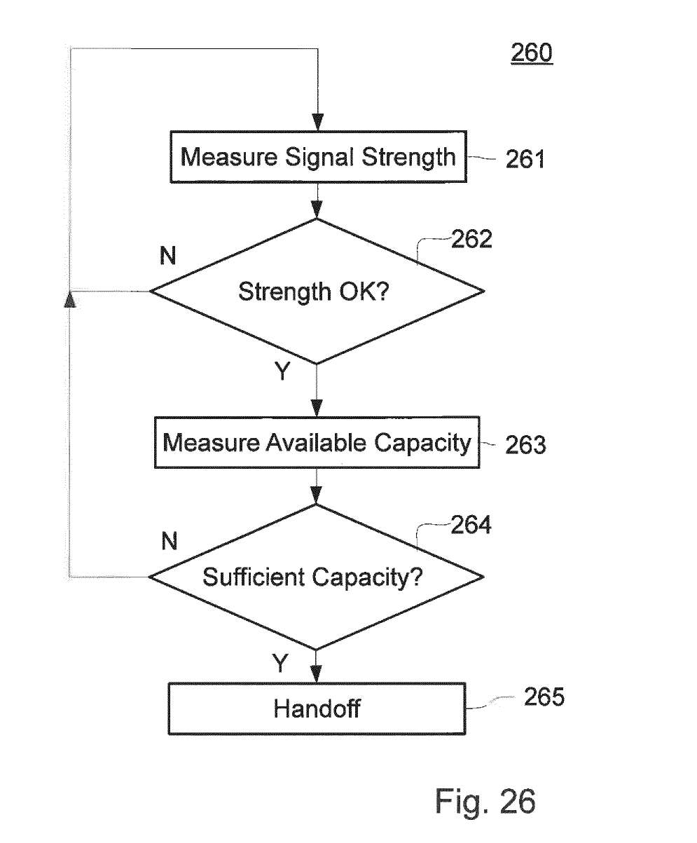

### DETAILED DESCRIPTION OF THE DRAWINGS

The present application provides a system in which one client STA in a WLAN having a QAP, performs measurements for a plurality of different traffic types being communicated via the wireless medium of the WLAN and where these measurements are employed to determine the respective bandwidth usage and availability of the different traffic types and where the system is configured to update the QAP with updated EDCA values to ensure that desired bandwidths are achieved for respective traffic types. Whilst the primary method of control is to calculate and set the QAP EDCA settings, it is also possible to do this for the other STAs on the network, whereby the QAP transmits the BSS EDCA values to other STAs in the WLAN within beacon management frames broadcast by the QAP.

All STAs associated with the QAP are obliged to use these EDCA settings assuming they are in conformance with the Wi-Fi standard, albeit in practice they may not conform. In contrast, the QAP is allowed to use its own EDCA settings as determined by wireless measurements performed by the system which may be different from those used by the associated STAs. Hence the operation of the QAP may be optimized in terms of its bandwidth utilization. This makes sense as most of the performance issues in a WLAN network are experienced at the QAP, since it is the point on the network through which all of the network traffic flows.

The method of the present application operates to allocate different types of traffic with a different bandwidth allocation and then adjusts the EDCA parameters accordingly in an effort to realize these. The EDCA parameters that may be adjusted include AIFSN, ECWmin, and ECWmax. Using this approach no single type of traffic (e.g. Background, Best Effort, Video or Voice) can overly dominate the bandwidth. The basic approach is to specify a minimum bandwidth requirement for each AC stream. This minimum bandwidth may be determined to meet a particular network operators QoS requirements or even business requirements where there may be different grades or tiers of access. The WLAN bandwidth controller then operates in such a way as to ensure that all ACs get their minimum bandwidth, i.e. to prevent one particular AC stream from effectively stealing all the bandwidth from the other ACs.

Conventionally, the approach to measuring bandwidth on a wireless network is directed at those aspects which are directly measurable including for example, the volume of data successfully transmitted. However, as outlined in earlier work of the present inventor, as described in detail in U.S. Pat. No. 7,664,031, knowing what has been successfully transmitted does not actually equate to knowing how much bandwidth capacity remains available. It is more beneficial to measure the performance of a wireless network not necessarily just on the basis of what may directly be measured but also to consider what is happening when there is no traffic apparently being broadcast on the wireless medium. It will be appreciated from U.S. Pat. No. 7,664,031 that this is not a straightforward process.

The present application attempts to take account of all active STAs on the medium, not just those associated with the QAP, e.g. STAs communicating with other APs or QAPs. It will be appreciated that solely performing measurements at the QAP based on throughput (e.g. as if it was a wired switch), ignores these other stations.

Whilst the techniques described in U.S. Pat. No. 7,664,031 are extremely useful, the method presented operates on the general assumption that each station is an AP rather than a QAP.

The present application improves upon this and is based upon a Bayesian analysis of the time intervals observed in the inter-packet times when the wireless medium is idle. This provides for accurate results using passive monitoring of the medium—i.e. by analysing the busy and idle times on the medium and the average access times being experienced by the contending stations. Furthermore, the impact of tuning actions to the EDCA parameters will have a much more direct and immediate impact (and hence more readily observed) on these parameters than they might on secondary metrics such as Acknowledgements and Re-transmission attempts.

The present application is based upon optimizing bandwidth availability, i.e. capacity or more accurately how its availability is shared out between contending streams. More precisely, it adjusts the EDCA settings to re-allocate transmission opportunities to each of the ACs according to their bandwidth requirements. It does not concern itself with throughput or delay which the present inventor has determined cannot reliably be used as QoS metrics given the contention based random access nature of the MAC mechanisms.

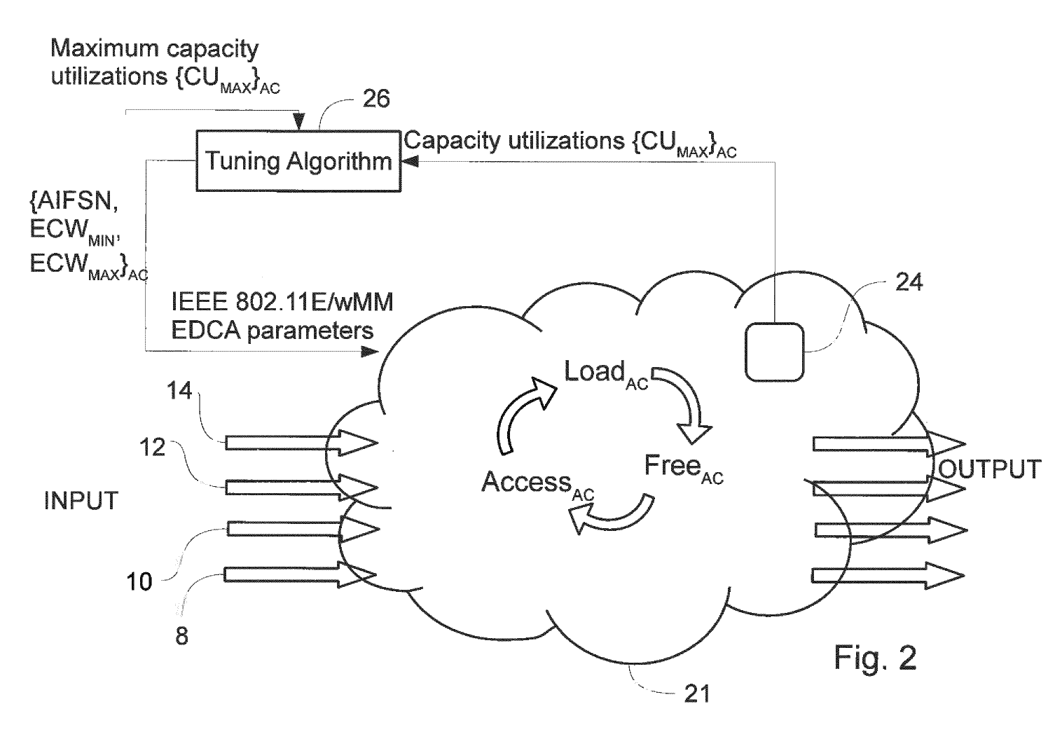

The WRM (i.e. Wireless Resource Monitor) 24 may be a discrete device or it may be an application that can be provided on an device which is already part of the network (for example an access point). The WRM, shown in exemplary form in the architecture of FIG. 2, passively monitors (i.e. “sniffs”) the wireless medium using an appropriate radio interface.

The figure represents how the four access classes 8, 10, 12, 14 coming from potentially many devices or applications within devices are competing for bandwidth on the wireless medium 21. As will be discussed below, three different components are employed to represent the bandwidth of the wireless medium in respect of each individual access class. These three different components for each access class are interdependent. These components are Load_{AC} representing the data which is actually transmitted, Access_{AC} which represents bandwidth utilised in gaining access to the wireless medium and Free_{AC} which represents unused or available bandwidth.

The WRM application provides measurements (capacity utilization values) to a tuning algorithm 26 which compares these with previously set values (Maximum capacity utilizations) and as a result adjusts the EDCA parameters for the wireless medium to cause the medium to converge as best as possible to the desired result.

As explained above, the WRM application may be implemented directly on a device such as an access point, for example within the firmware of the access point itself. In such an arrangement, the application shares the (radio interface) WLAN interface with other modules of the access point. In other arrangements, a separate device may be provided to the access point. However, it will be appreciated from the discussion which follows that the only real item of difference between these different implementations is that of how the access point ECDA values are then updated (explained in greater detail below) as the measurement process and analysis conducted is generally the same. Although, it will be appreciated that the WRM should be positioned to be relatively close to the access point so that it generally perceives the wireless medium as if it were the access point. It will be appreciated that this will depend on the environment, in which the access point is deployed, the characteristics of the access point and the WRM. However, generally reasonable results may be obtained if the WRM is within 10 meters. Preferably, the WRM is within 3 meters of the access point.

In particular, passive measurements are analyzed and processed using a mathematical framework in order to construct a picture of bandwidth usage. These measurements construct a picture of bandwidth availability for all users on the medium, irrespective of whether they are associated with the network or not. Accordingly, the WRM application considers users external to the WLAN (e.g. a device connected to another WLAN but which is within the reception area of the WLAN being monitored) and non-QoS, older legacy, STAs). Essentially, any active WLAN device (STA or AP) on the operating channel within reception range of the WLAN bandwidth controller is measured, analyzed and included in the EDCA calculations.

Adjustments are made to the EDCA parameters of the QAP. It will be appreciated that it is not necessary to apply them locally to each device on the wireless medium. The system does not attempt to predict the best EDCA values, instead a controller within the WRM uses a radio resource control (RRC) algorithm which employs a feedback loop whereby a tuning algorithm 26 makes “smart adjustments” to the EDCA values and the resulting changes in the bandwidths are measured which are then fed back into the tuning algorithm of the controller to further refine the EDCA adjustments. This feedback loop, represented graphically in FIG. 2, generally attempts to force the system to converge to the required bandwidth distribution. This required bandwidth distribution may for example be specified by the network manager through default values or settings configured through a suitable administrator interface.

The feedback loop of the controller also forces the EDCA settings to follow changes in the network load conditions. The controller suitably updates the EDCA settings on the AP. In the case where the controller is integrated with the AP then clearly this is a relatively straightforward task for the AP designer to implement using either software or hardware or a combination of the two.

Clearly, where a separate standalone device is provided to the access point then it will be necessary to communicate with the AP to update the EDCA settings on the AP. Accordingly, a communications interface (not shown) may be provided to communicate these updated EDCA settings to the QAP. These EDCA settings may be communicated to (and updated on) the QAP in a number of different ways. For example, the EDCA settings on some QAPs may be set “on the fly” by updating firmware values. Thus the communications interface may cause the firmware values to be updated by establishing a remote connection to the QAP. For example, the remote connection may use a telnet or ssh session to connect to the QAP and then direct control of its operation through a command line interface (CLI). Scripting techniques for doing these methods would be familiar to those skilled in the art.

Depending on the QAP, alternative methods may be employed for the communications interface to update the ECDA settings, for example certain enterprise grade equipment may provide for updating the EDCA settings through messages sent through the SNMP system. The WRM and its associated communications interface may be implemented in a standalone device or integrally within an AP. The advantage of a standalone device is that the method may be deployed into existing networks. The software required to functionally implement the WRM is a relatively lightweight application which does not require intensive computational effort for its operation. As will be discussed below, the model does not require excessive optimization effort for its solution. Confidential practical demonstrations have confirmed this to be the case. In some configurations, one or more measurement devices may be provided for measuring a network. These measurements in turn may be provided to a further device which determines an update the ECDA settings. Once the update has been determined, it may then be communicated to the access point to update its values.

The operation of the WRM and the tuning algorithm will now be described in greater detail and with reference to the general background which follows.
The WLAN Bandwidth Controller (comprising the WRM and tuning algorithm) is based conceptually upon the MAC Bandwidth Components framework that are described in detail in the WLAN Probe patent (U.S. Pat. No. 7,664,031), the contents of which are herein incorporated by reference.
Generally stated, the concept presented in U.S. Pat. No. 7,664,031 is that associated with each station (STA) broadcasting on a wireless medium are 3 coupled normalized bandwidth components:
BW_{load} which corresponds to the fraction of the channel bandwidth consumed by a STA in the transmission of its wireless frames.
BW_{access} which corresponds to the fraction of the channel bandwidth required by a STA to win transmission opportunities for its wireless frames.
BW_{free} which corresponds to the fraction of the channel bandwidth that is unused by the STA.
   The calculation of the normalized BW_{load} component is relatively straightforward as it requires information on the modulation format (i.e. the PHY mechanism) used, the size of the frame and the transmission rate, all of which are easily measured.
   Whilst, the calculation of the BW_{load} component from measurements taken by the wireless interface of the WRM, other aspects are not straightforward.
   Indeed, a challenging aspect of the WLAN bandwidth controller is the calculation of the normalized BW_{access} component. This requires an estimation of the average time required to win a transmission opportunity, i.e. the average time required by a STA (or more accurately its MAC mechanism) to get its backoff counter (BC) to reach zero. Given the inherently statistical nature of the MAC process, this requires a statistical approach to its estimation.
   Furthermore, it will be understood by those skilled in the art that is not possible to measure this time directly. Accordingly, an indirect approach is used where the access time is inferred indirectly from a measurement of the level of competition for access being experienced by the STA or STA AC. In this context, it should be appreciated that the present application can be used to account for QoS devices and non-QoS devices. Thus a STA may have just one STA AC. Thus for convenience of explanation, the terms STA and STA AC may be used interchangeably herein unless the context specifically requires otherwise.
   This indirect approach employs a statistical analysis of the channel idle intervals between frame transmissions, i.e. the inter-frame time intervals. Whilst different methods may be employed, in this application a Bayesian decision process is used to perform this statistical analysis (discussed in greater detail below). Some terms and concepts will now be introduced which may employed to advantage when implementing a WLAN bandwidth controller.

### Access Efficiency

In the context of the present application, access efficiency ηₐ is a parameter that emerges from the MAC Bandwidth Components framework. It may be useful in determining the ability of a STA to seize channel bandwidth. The access efficiency ηₐ is defined as the ratio of the BW_{load} component to the BW_{access} component, as follows:

$${η}_{a} = \frac{{BW}_{load}}{{BW}_{access}} \qquad ( 1 )$$

Since the bandwidth of the channel is shared on a WLAN, this means that a STA with a large access efficiency is actually gaining bandwidth at the expense of another STA with a smaller access efficiency. The calculation of the capacity of a STA is related to its access efficiency. It will be appreciated that there is also an access efficiency associated with each class of traffic transmitted by a STA_{AC}.

Access Efficiency Factor (AEF)

A potentially more useful parameter that is introduced in this application which is related to the access efficiency ηₐ is the concept of an access efficiency factor (AEF). This AEF may generally be defined as

$$AEF = \frac{{η}_{a}}{1 + {η}_{a}} = \frac{{BW}_{load}}{{BW}_{load} + {BW}_{access}} \qquad ( 2 )$$

The AEF is a useful parameter in determining the capacity experienced by a STA. Moreover, it may be extended to determine the capacity experienced by a class of traffic for the STA or STA AC(STA_{AC}).

### Station Capacity

A further concept introduced is that of station (STA) capacity. A definition of STA capacity is the maximum value of BW_{load} that may be achieved by a STA under current network load conditions.
It thus represents the upper limit on the BW_{load} that may be transmitted before saturation occurs.
The capacity C(i) of a STA i depends on its AEF(i) value and the BW_{load} of the other STAs that it is competing with for transmission opportunities,

C(i)=AEF(i)[1−Σ_{j≠i}BW_{load}(f)] (3)

It will be appreciated that the values of BW_{load} are normalized with respect to overall bandwidth.
The application of expression 3 is a general basis suitable for implementation within a WLAN bandwidth controller.

A further concept, which is introduced in this application, is that of Capacity Utilization. A useful performance metric for a STA is the capacity utilization CU. The CU describes how close to saturation a STA is operating. The capacity utilization CU(i) of a STA i may be defined as the ratio of the BW_{load}(i) component to its capacity C(i),

$$CU ( i ) = \frac{{BW}_{load} ( i )}{C ( i )} = \frac{{BW}_{load ( i )}}{AEF ( i ) [ 1 - {\sum }_{f \neq t} {BW}_{load} ( f ) ]} \qquad ( 4 )$$

A capacity utilization CU of 1.0 indicates saturation, i.e. the data being successfully transmitted by a station is at its maximum throughput on the wireless medium.

Once a figure for capacity utilization has been determined, it may be used in control mechanisms for access to networks for example in admission control schemes and handoff mechanisms e.g. ANDSF.

### Contention

It will be appreciated that having a reasonably accurate measure of the different components occupying the wireless medium is important to ensure that the subsequent tuning algorithm is operating using values which reflect what is happening.
Thus, determining accurately factors such as the AEF value for each station i,AEF(i), is generally important to the operation of the WLAN bandwidth controller.
Estimating the AEF requires an estimation of the average access time which in turn requires an estimation of how long (on average) it takes for the BC to reach zero and thereby win a transmission opportunity.
Ultimately, it will be appreciated, that this time will be determined by how often a STA has had to stop and re-start the decrementing (known as deferring to a busy medium condition) of its BC due to a busy channel condition arising from transmissions from other stations sharing the channel. This interaction between competing STAs is termed contention and it essentially describes the level of competition between STAs to win transmission opportunities. This concept of contention and more particularly how to measure it, is beneficial in implementing the WLAN bandwidth controller of the present application.
The contention is defined as the average number of STAs that a STA competes with in winning a transmission opportunity. The smallest value of contention is 1.0 which corresponds to a single STA competing for access, i.e. no competition. For example, if a STA were to experience a contention level of 2.0, then it would on average always be competing with one other STA (not necessarily the same STA each time) in order to win transmission opportunities.
Whilst different methods may be employed to estimate contention. The present application employs a Bayesian analysis of the idle time intervals observed in the inter-frame transmission times. This is an extremely efficient approach. More specifically, a Bayesian decision process is used to analyse the idle inter-frame transmission times in order to optimally determine if two STAs have competed for a particular transmission opportunity. This decision process is applied to each transmission from a STA and averaged over all the transmissions for the STA (in the measurement interval of interest) to produce the average level of contention experienced by the STA in winning a transmission opportunity. This procedure is repeated for every actively competing, i.e. contending, STA on the channel.
A look-up table (based upon an ordered tree data structure) may then be used to provide the average access time corresponding to the measured average contention level. The use of an ordered tree structure as a look-up table provides support for IEEE 802.11e WMM operation as different STAs may be competing with different sets of access EDCA parameters where each node on the data tree corresponds to a particular combination of competing set(s) of EDCA parameters.
Once the average access time for a STA i has been estimated, its BW_{access}(i) component may be obtained and hence the access efficiency factor AEF(i) can be calculated using equation (2). By combining this with measurements of the BW_{load} components of the other STAs, its capacity C(i) may then be calculated using equation (3).

The estimation of the contention experienced by a STA is important to the measurement of its capacity.

Bayesian Contention Estimation Process

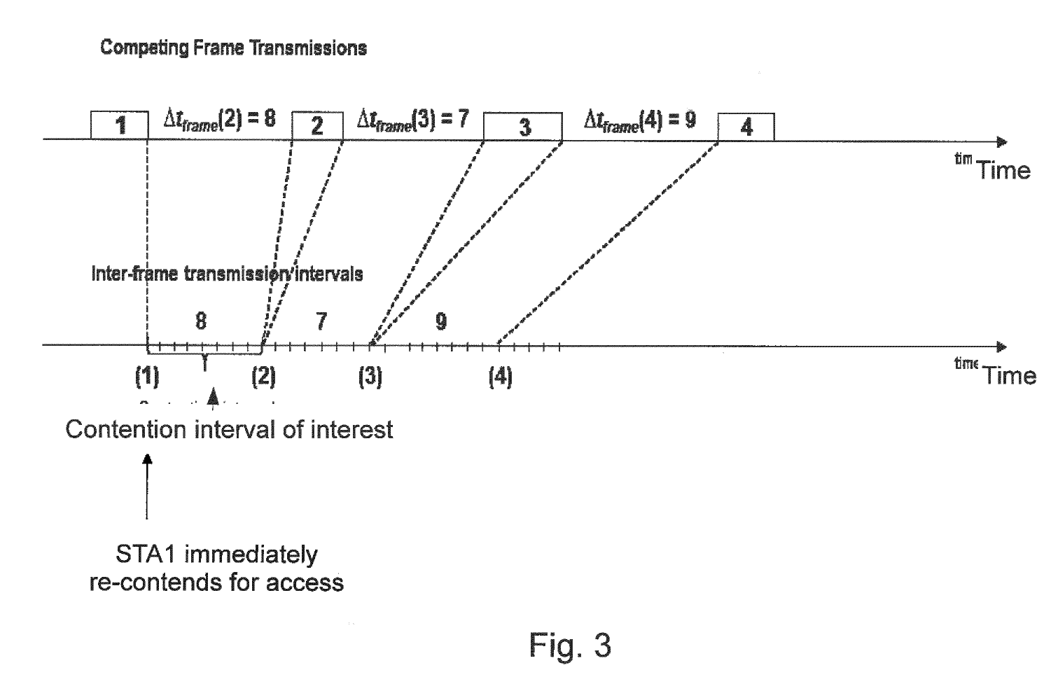

FIG. 3 illustrates a process for determining whether a STA has competed for access within a given contention interval. A number of STAs are competing for access to the medium. The interframe intervals observed between the transmitted frames are shown in terms of the number of timeslots. In the IEEE 802.11 standard the time is slotted into units of 10 μs. The contention interval of interest is the interframe interval immediately following the first transmission of STA 1.

STA 1 will be contending since under the IEEE 802.11 MAC rules, it should initialize its backoff counter (BC) immediately following a transmission.

STA 2 will be contending with STA 1 in the interval of interest (between transmission from STA 1 and STA 2) only if its initial BC value (BCᵢₙᵢₜᵢₐₗ) is greater than or equal to 8 in the exemplary situation shown. Since the value BCᵢₙᵢₜᵢₐₗ is randomly and uniformly selected from the range [0, CW] where CW is the contention window size, the probability of this occurrence (assuming for example a CW=31) is

$$P [ STA 2 contended ] = P [ {BC}_{initial} ( 2 ) \geq 8 ] = \frac{CW - 8}{CW + 1} = \frac{31 - 8}{32} = 0.72 \qquad ( 5 )$$

Similarly, STA 3 will be contending in the interval of interest (between transmission from STA 1 and STA 2) only if its BCᵢₙᵢₜᵢₐₗ value is greater than or equal to 8+7=15. Similarly, the probability of this occurrence is

$$P [ STA 3 contended ] = P [ {BC}_{initial} ( 3 ) \geq 15 ] = \frac{CW - 15}{CW + 1} = \frac{31 - 15}{32} = 0.5 \qquad ( 6 )$$

STA 4 will be contending in the interval of interest only if its BCᵢₙᵢₜᵢₐₗ value is greater than or equal to 8+7+9=24. Similarly, the probability of this occurrence is

$$\begin{matrix}P [ STA 4 contended ] = P [ {BC}_{initial} ( 4 ) \geq 24 ] \\ = \frac{CW - 24}{CW + 1} \\ = \frac{31 - 24}{32} \\ = 0.22\end{matrix} \qquad ( 7 )$$

In general, it may be stated that if x is the number of time slots (where no transmission occurs) between the start of the contention interval of interest and the transmission of the frame and CWᵢ is a given contention window size, the conditional probability

$$P [ {BC}_{initial} ( {CW}_{i} ) \geq x \vert {CW}_{i} ] = \frac{{CW}_{i} - x}{{CW}_{i} + 1} \qquad ( 8 )$$

corresponds to the case of the station contending for access in the contention interval of interest. Conversely, the conditional probability

$$P [ {BC}_{initial} ( {CW}_{i} ) < x \vert {CW}_{i} ] = \frac{x}{{CW}_{i} + 1} \qquad ( 9 )$$

corresponds to the case of the station not contending for access in the contention interval of interest.

Under the IEEE 802.11 standard the size of the contention window is known—CWᵢε{15, 31, 63, 127, 255, 511, 1023} depending on the modulation scheme (or the PHY) used and if a frame re-transmission is being undertaken. For example, the PHY mechanism employed in the case of IEEE 802.11b is DSSS, in IEEE 802.11g is OFDM and in IEEE 802.11n is MIMO.

From the discussion above, it will be appreciated that the problem of determining whether a STA has contended within a contention interval is generally a binary decision process. As a result of which, a Bayesian decision theory may be used to minimize the probability of making an incorrect decision. Specifically, a minimum probability of error may be achieved using the Likelihood Ratio Test (LRT). In this case, we use a version of the LRT that seeks to maximize the a posteriori conditional probability and is known as the Maximum A Posteriori (MAP) criterion.

The MAP criterion is

$$\frac{P [ {BC}_{initial} ( {CW}_{i} ) \geq x \vert {CW}_{i} ]}{P [ {BC}_{initial} ( {CW}_{i} ) < x \vert {CW}_{i} ]} {{≷}_{NC}}^{C} 1 \qquad ( 10 )$$

Where C denotes contention and NC denotes no contention.

Substituting for the conditional probabilities, the MAP criterion becomes

$$\frac{\frac{{CW}_{i} - x}{{CW}_{i} + 1}}{\frac{x}{{CW}_{i} + 1}} {{≷}_{NC}}^{C} 1 \qquad ( 11 )$$

Which simplifies to:

$$x {{≷}_{C}}^{NC} \frac{1}{2} {CW}_{i} \qquad ( 12 )$$

In other words, if

x≦½CWᵢ

make the decision that station i has contended (C) and if

x>½CWᵢ

make the decision that station i has not contended (NC)

Hence, we can define a threshold value y=½CWᵢ that results in the following simple decision rule for determine whether a station has competed for access in any contention interval.

$$x {{≷}_{C}}^{NC} γ \qquad ( 13 )$$

Where x is the number of time slots between the start of the contention interval of interest and the transmission of the station's frame.

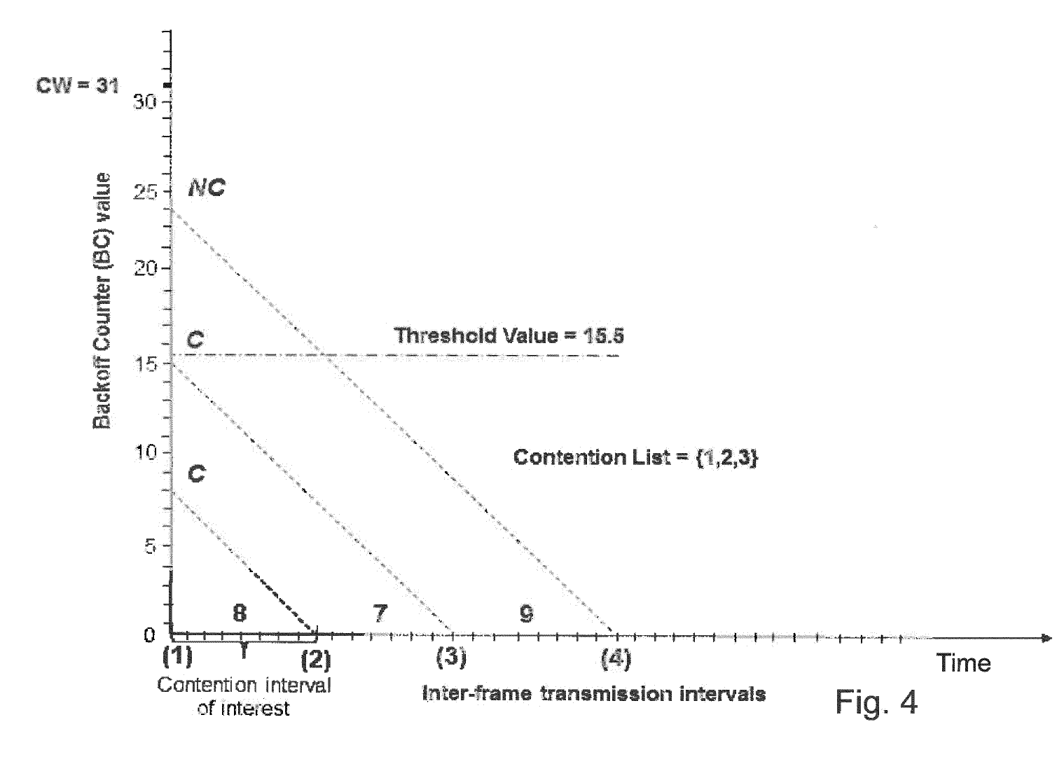

In terms of the example illustrated in FIG. 4, which corresponds to the situation of FIG. 3, this means that STAs 1, 2, and 3 are considered to have participated in the contention interval of interest as they fall below the threshold of 15.5. However, STA 4 is considered not to have participated in the contention process since the CW value is 31 and so the threshold value for determining contention is 15.5, whereas the number of inter frame transmission intervals from the start of the interval of interest to the transmission of a frame from station 4 is 24 (8+7+9).

Implementing the concepts will now be described with respect to an exemplary practical implementation which provides a device which may be used to update EDCA parameters in a wireless area network having an access point.

The device suitably has a wireless interface for receiving packets broadcast on the network. It will be appreciated that this amounts generally to a Wi-Fi enabled device.

However, the device must be capable of presenting certain information to a subsequent analyser associated with the wireless device for analysis of the received packets to determine access efficiency values. Whilst, this may readily be performed if complete access is available to all components on the wireless device, it may not be possible with certain types of Wi-Fi devices where the manufacturer has closed off detailed access to certain components, notably the wireless interface.

Preferably, the function of the analyser is embodied within the wireless device.

The information generally required by the analyser comprises PHY information as well as information with respect to the packet contents (discussed below with reference to Radiotap).

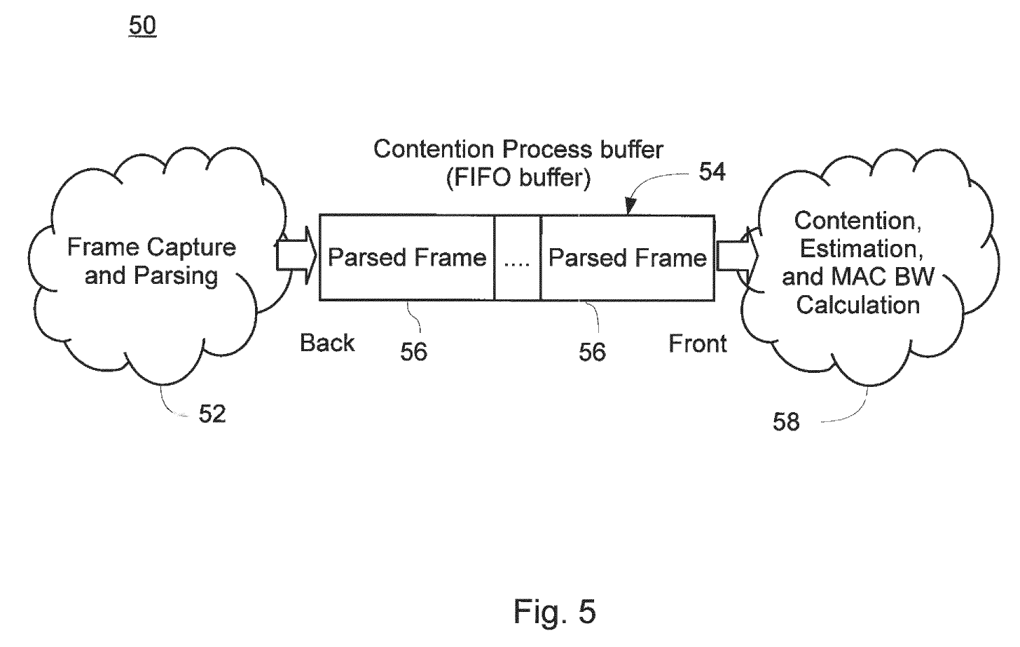

The estimation 50 of the MAC BW components by this analyser employs generally two coupled processes, a Frame Capturing and Parsing process 52 and a Contention Estimation and MAC BW Calculation process 58 as shown in FIG. 5. The two processes are coupled. This coupling is suitably via a FIFO (first-in, first-out) buffer, referred to herein as the Contention Process buffer 54, that temporarily stores the captured and parsed IEEE 802.11 frames 56 before being further processed to estimate the contention and to calculate the MAC BW components.

Frame Capture and Parsing

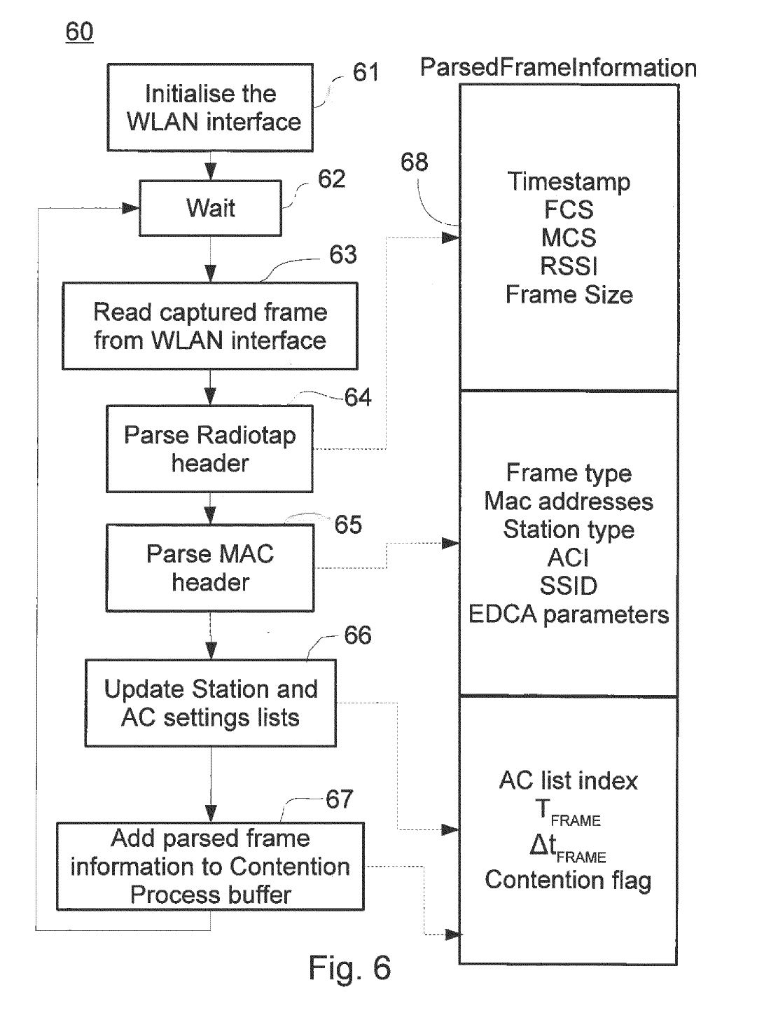

FIG. 6 shows an exemplary flowchart of a Frame Capture and Parsing process 60. The process captures IEEE 802.11 frames. The captured frames are parsed to extract useful information. Specifically, each captured frame is parsed to populate a Parsed Frame Information structure before being pushed into the Contention Process buffer. The Parsed Frame Information Structure which is created for each frame and contains a number of parameters associated with the frame. Some of these values are available directly from the frame itself, these include the Timestamp, FCS, MCS, RSSI and Frame Size values which are directly retrievable from the frame header.

This parsed information may be provided to a separate device to perform subsequent analysis. For example, in one variation, an Access Point is configured to perform the frame capture and parsing steps. The parsed frame information is then transmitted to another entity (e.g. a server) where further analysis as described herein is performed and then updated settings passed back to the Access Point.

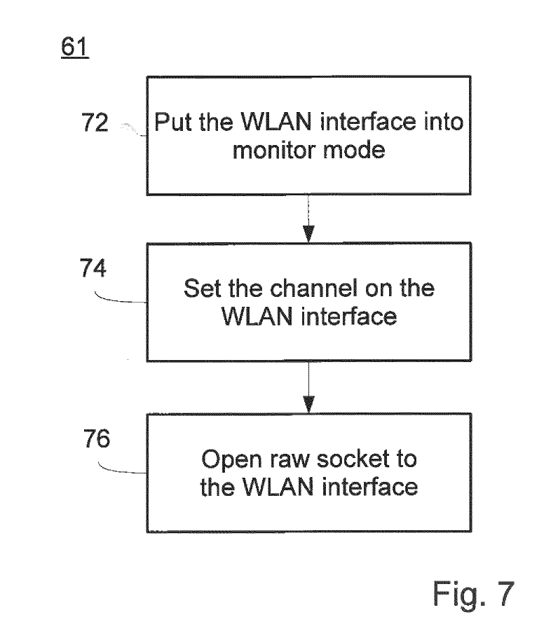

With respect to FIG. 6, a first step 61 in the exemplary Frame Capture and Parsing process is to initialize the WLAN interface, illustrated in detail in FIG. 7. When implemented in a standalone device, this step involves initially putting the WLAN interface into a monitor mode 72. In this mode, the radio interface passively captures all IEEE 802.11 frames within its reception range. This mode is sometimes referred to as the promiscuous mode. It will be appreciated that this is generally because of the nature of the existing WLAN interfaces.

The next step is to set the radio channel that the WLAN interface will operate on 74. It will be appreciated that this is suitably the radio channel employed by the QAP, which is being monitored for performance. It will be appreciated that these steps may require operator input. The final step 76 is to open a raw socket to the WLAN interface. A raw socket an internet socket that allows direct sending and receiving of Internet Protocol (IP) packets without any protocol-specific transport layer formatting. Essentially, it allows a user space application to communicate directly with an interface driver. In this case it provides the Frame Capture and Parsing process with direct access to captured IEEE 802.11 frames.

Once the WLAN interface has been initialized, the Frame Capture and Parsing process is run as a continuous loop which involves waiting 62 for a new IEEE 802.11 frame to be captured, reading the captured frame 63 and parsing the frame in a series of steps 64, 65 and then pushing 67 the parsed frame information 68 into the Contention Process buffer 54.

When a new frame is received by the WLAN interface, the process leaves the Wait state 62 and the new frame is read 63 from the interface for parsing. The parsing is a two stage process. More particularly, in the exemplary process described here, it is assumed that the WLAN interface is capturing the radio (PHY) layer packets and encapsulating them with the radio (PHY) layer information.

The standard format in which this presented in the art is Radiotap (http://www.radiotap.org/), which is generally recognised as a de facto standard for IEEE 802.11 frame injection and reception. However, it is not the only format and other proprietary and non-proprietary formats are known. Nonetheless, Radiotap is employed herein for the purposes of the explanation which follows it is assumed that this is what is used.

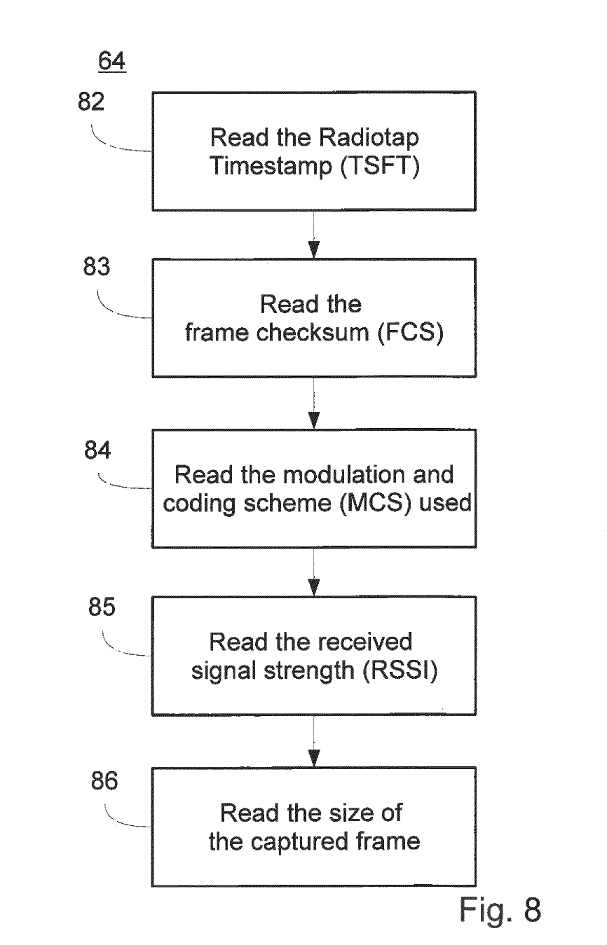

Thus, as shown in FIG. 8, a first stage 64 uses a series of steps (the sequence of which is not important) to parse the Radiotap header in order to extract PHY layer information on the captured frame. This has been prepended to a captured frame by the WLAN interface driver in order to provide PHY layer information.

In a first step of this first stage, the timestamp is read 82. The timestamp reflects the time at which a frame was captured. This is useful information as the general basis for the technique of the present application, as described above, is based generally upon a Bayesian analysis of the interframe time intervals. It will be appreciated that the time reference for the timestamp is not important since it is relative timing rather than absolute timing that is important.

A second step reads 83 the Frame Check Sum (FCS). The FCS is a flag which indicates whether a frame has been successfully captured or not (i.e. whether the packet was corrupted or not).

Corrupted frames are suitably discarded in the process employed herein as the information they contain is unreliable.

A third step reads 84 the Modulation and Coding Scheme (MCS). The MCS information indicates the modulation scheme used and the transmission rate (i.e. line rate or PHY rate) used to transmit the frame. This information is used to determine the duration of the frame transmission which is in turn used to calculate the traffic load and to calculate the interframe time interval.

A fourth step 85, is used to read the Received Signal Strength (RSSI). The RSSI indicates the strength of the received signal that conveyed the frame. This information may be used to manage the updating of the station list information.

A final step 86 reads the captured frame size. The frame size (suitably in bytes) may be used to calculate the duration of the frame.

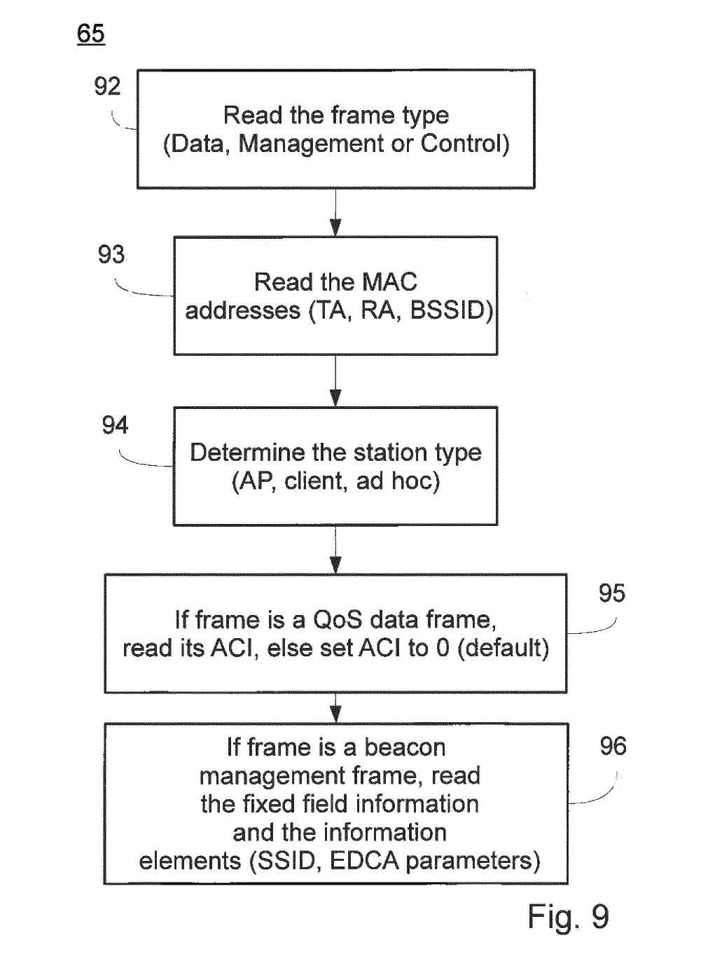

A second parsing stage 65 involves parsing the MAC header and employs a series of steps, as shown in FIG. 9, on the captured frame.

A first step 92 reads the frame type. There are three basic frame types supported in IEEE 802.11, Data frames, Management frames, and Control frames. The data frames carry the user traffic and are used to calculate the throughput. The management frames are used to manage the operation of the WLAN and contain much valuable information, specifically the values of the EDCA parameters being used which are contained in the Information Elements transmitted in beacon frames. The control frames are used to coordinate the operation of the WLAN, e.g. to ensure that frames that are successfully received are acknowledged.
A second step 93 obtains the MAC addresses within the frame. Every data frame contains the MAC address of its intended recipient (RA). Most data and management frames also contain the MAC address of the transmitting station (TA). An important MAC address is the BSSID which is used by client stations to indicate the AP or QAP that the client station is associated with.
A third step 94 determines the station type. Data and management frames usually contain flags (i.e. the ToDS and FromDS flags) that indicate the type of station that transmitted the frame, i.e. AP, client, ad hoc (IBSS) or bridge (WDS).
A fourth step 95 determines the Access Category Index (ACI) for each data frame and sets others to be 0. All data frames transmitted by a QoS enabled station will contain an ACI that indicates the AC queue that transmitted it. By default, management frames are assigned an ACI=3 and non-QoS data frames are assigned an ACI=0.
A final step 96 determines if the frame is a beacon management frame and if it is, reads the SSID and ECDA parameters. The SSID (Service Set Identifier) is broadcast by an AP or QAP to indicate the presence of a WLAN. It essentially serves as the name of the network and is used by client stations to discover and associate with WLANs. Each QoS enabled AP (QAP) transmits 4 sets of EDCA parameters values associated with each of the ACs contained in the AP. Client stations associating with such an AP are required to adopt these EDCA parameter values for their transmissions. The EDCA parameters are broadcast in Information Elements within Beacon management frames.

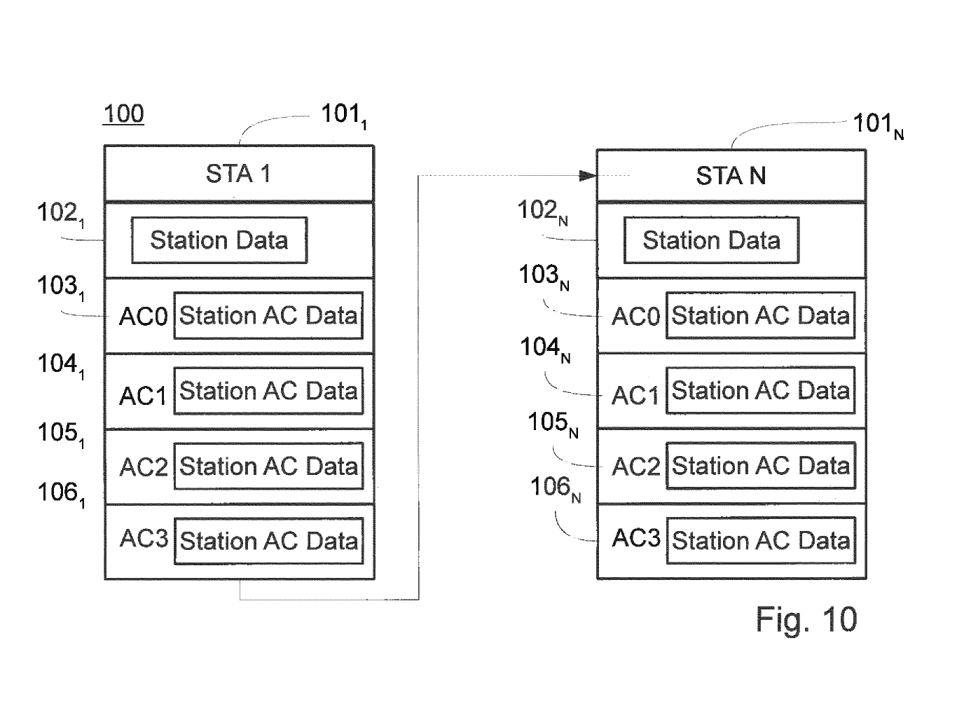

Once the parsing of the captured frame is complete, the parsed information is used to update a Station List 100 and an AC Settings List 110. The station list, illustrated by the example of FIG. 10, is a list 100 which contains station information on the plurality of stations 101_{1-N} which have been detected transmitting a frame. This station information contains information relating to the station 102_{1-N} along with information with respect to each of the access classes of the station 103_{1-N}, 104_{1-N}, 105_{1-N}, 106_{1-N}.

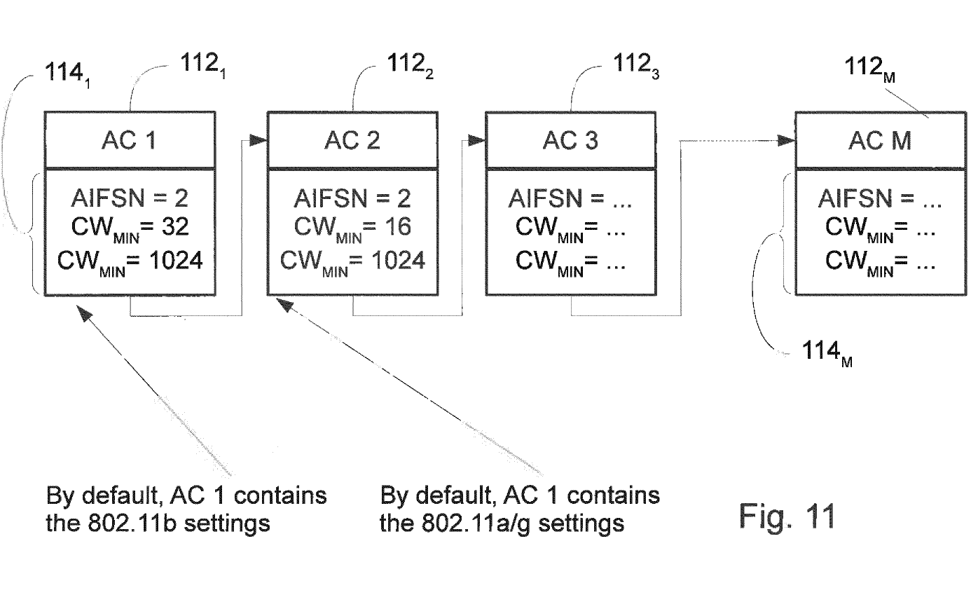

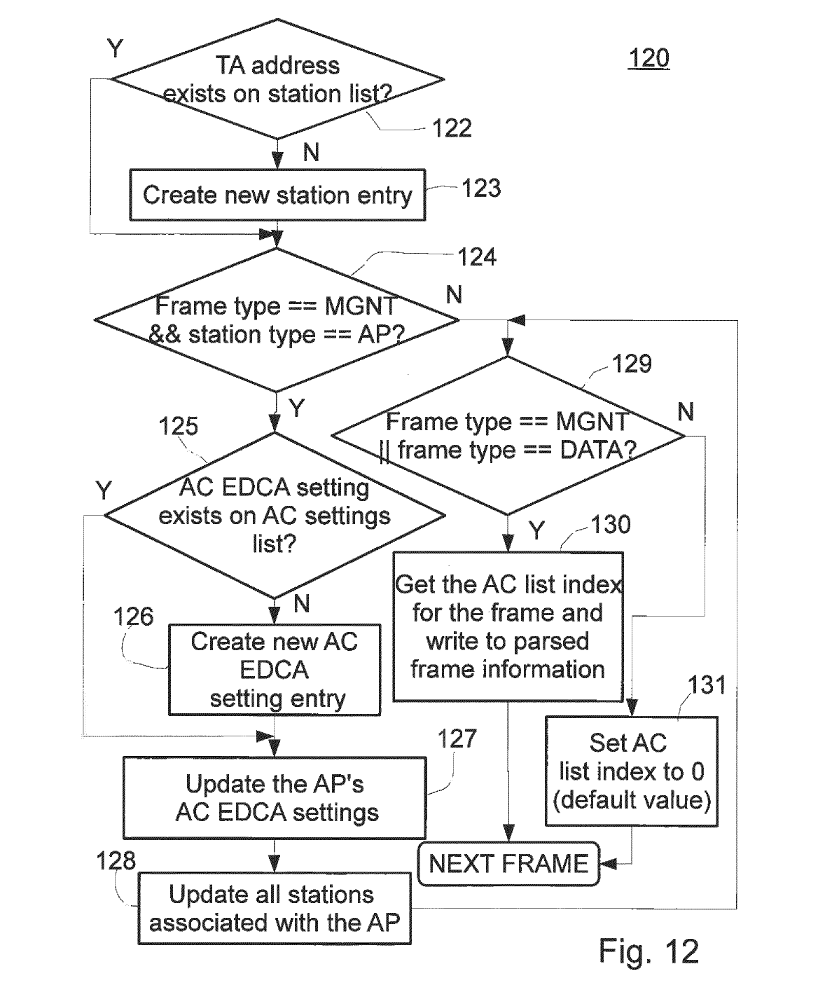

The AC Settings list 110, illustrated for the purposes of explanation in FIG. 11, contains ECDA information 114_{1-N} on any detected set 112_{1-M} of AC values present on the wireless medium. The process maintains these two lists for managing the active stations (i.e. the Station list) and the EDCA settings (i.e. the AC Settings List). These two lists are maintained and suitably updated from the parsed frame information and this process in illustrated by the exemplary process 120 shown in the flowchart of FIG. 12.

Firstly, the TA of the captured frame is checked 122 to establish if it currently exists in the Station List. If not, a new station entry is created 123 in the Station List. Next, a check is made to determine 124 if the captured frame is a management frame from an QAP. If it is a management frame, it is used to maintain/update the AC Settings List and to update the EDCA settings used by the QAP and the any stations associated with the QAP. Firstly, it checks if each of the captured EDCA settings exists on the AC Settings List 125. If not, a new AC Setting entry is created 126 on the AC Settings List. Next, if the QAP's EDCA Settings have changed, they are updated 127. Also, the EDCA settings of all the stations associated with the QAP are also updated 128.

Finally, for data and management frames only, the captured frame is assigned 130 an AC List Index. This indicates the EDCA settings used by the MAC of the AC queue used to transmit the frame. This information will be used later in the Contention Estimation Process to estimate the participants in the contention process that resulted in its transmission. Control frames are assigned 131 an AC list index of 0 (default value).

The final step in the Frame Capture and Parsing process is to add the parsed captured frame information to the Contention Process buffer. However, there are two pieces of information that are first determined:
the interface time interval Δt_{frame}
whether the frame has contended for access, i.e. to set/reset the Contention flag in the Parsed Frame Information structure.

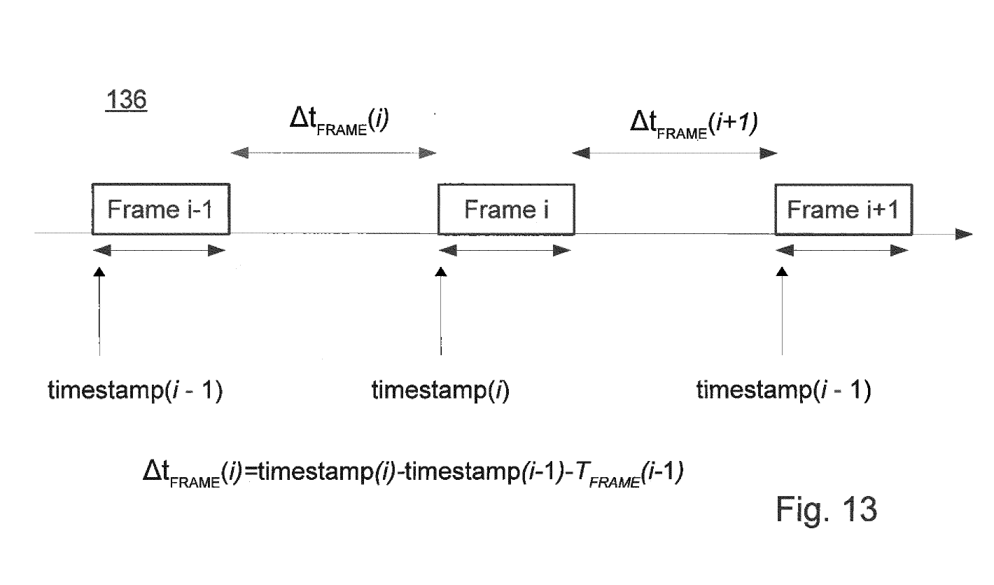

The interframe time interval Δt_{frame}(i) of a frame may be defined as the time interval between the end of the previous frame transmission and the beginning of the current frame transmission, i.e. it represents the idle medium time between successive frame transmissions, as illustrated in the sequence 136 FIG. 13. For example, if the timestamp corresponds to the beginning of the frame the interframe time interval Δt_{frame}(i) for frame i is given by

Δt_{frame}(i)=timestamp(i)−timestamp(i−1)−T_{frame}(i−1) (14)

where timestamp(i) is the timestamp of the ith frame and T_{frame}(i−1) is the duration of the frame preceding the ith frame.

In some cases, the timestamp of the captured frame may correspond to the end of the frame. In this case the frame the interframe time interval Δt_{frame}(i) for frame i is given by

Δt_{frame}(i)=timestamp(i)−timestamp(i−1)−T_{frame}(i) (15)

The transmission time of the captured frame T_{frame} is calculated from the frame size and MCS information parsed from the Radiotap header. It will be appreciated that T_{frame} may readily be calculated for each of the PHYs by application of the definitions provided in the IEEE 802.11 standards.

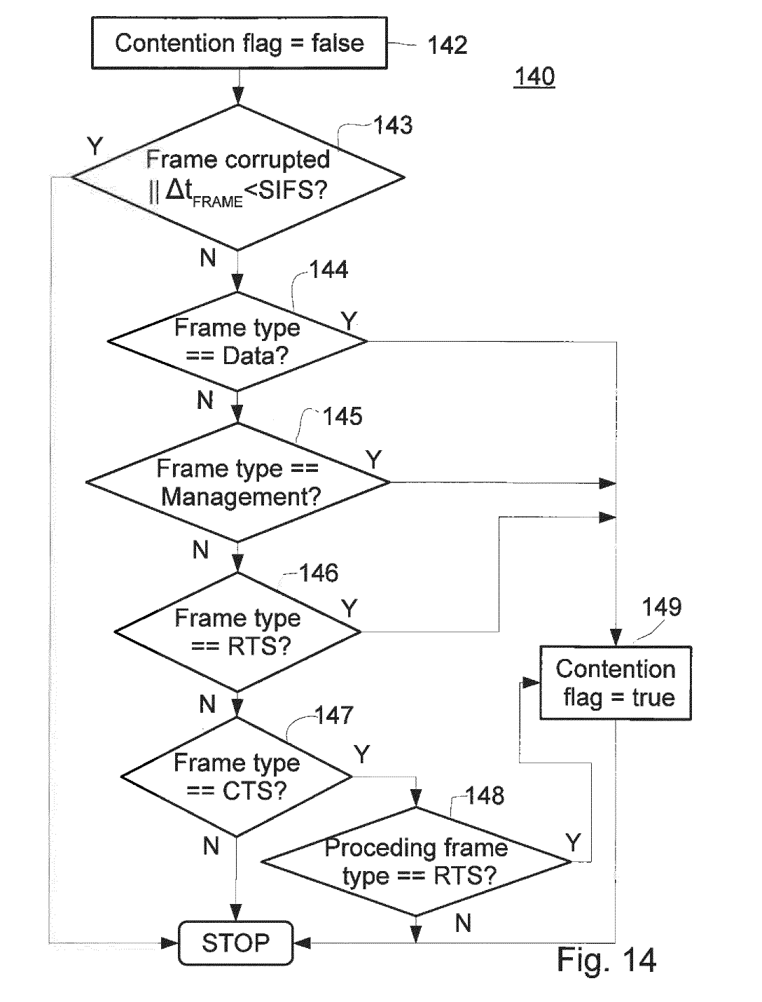

An exemplary process 140 for determining whether a captured frame has contended for access is shown in the flowchart in FIG. 14. Initially, the frame is assumed to have not contended for access, i.e. a Contention flag is set 142 to be false. A check is performed 143 to determine if the frame is corrupted (as determined by the FCS flag in the Radiotap header) or if the interframe time interval Δt_{frame}(i) is less than SIFS. If it is then the process is immediately terminated for that frame.

If the frame is uncorrupted and if the interframe time interval Δt_{frame}(i) is greater than SIFS and if the frame is a data or management frame then the frame will have contended for access. Accordingly, tests 144, 145 are performed to check whether the frame is a data or management frame. Where a frame is determined to be a data or management frame, the contention flag is set 149 to be true.

Control frames will not have contended for access apart from one notable exception, namely the RTS/CTS exchange that is used in environments containing hidden nodes. Accordingly, a test 147 is performed to determine if the captured frame is a CTS control frame and then to determine 148 whether the preceding frame is a RTS control frame. Where this occurs, the contention flag is set 149 to be true.

In all other cases the contention flag is left as false.

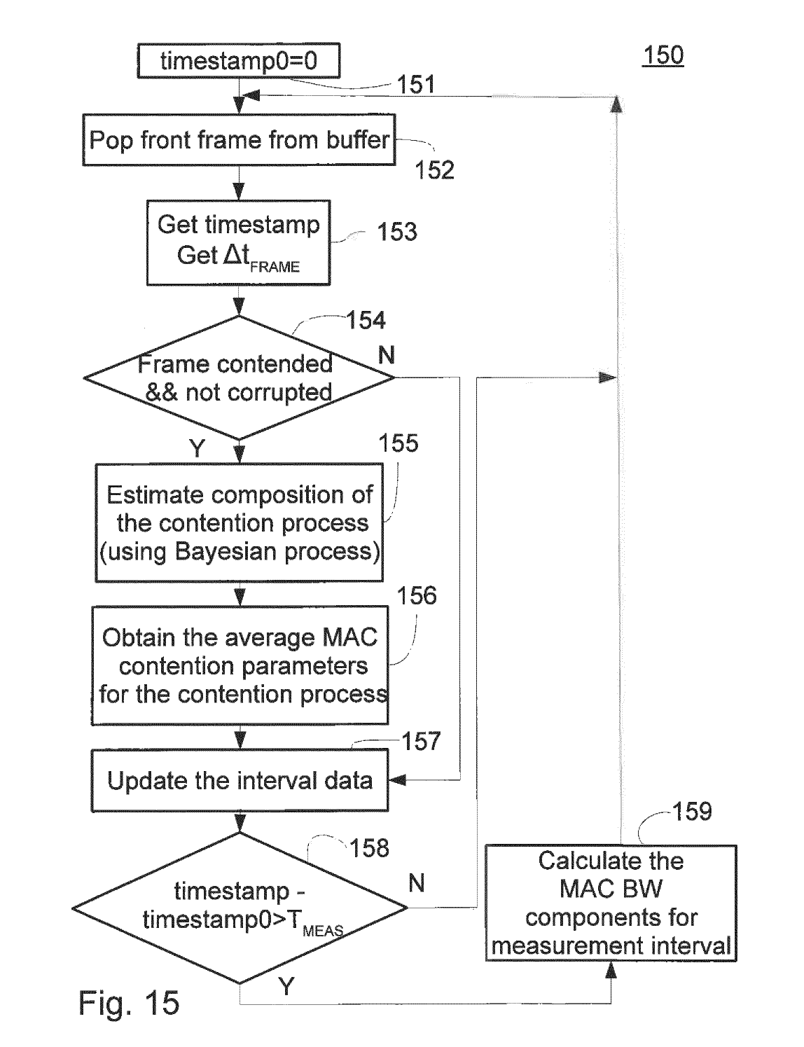

The Contention Estimation and MAC BW Calculation Process 58 will now be described. The purpose of this process (as shown in the exemplary process flow 150 of FIG. 15) is to calculate MAC BW parameters for each of the active STAs (or more accurately the STA ACs) in the Station List by processing their frame transmissions that have been captured, parsed and stored in the Contention Process buffer.

In particular, the general objective is to determine the average access time for each of the STA ACs. It will be appreciated that the average access time may be calculated by averaging the MAC access parameters over each of the contention processes that the STA AC has successfully won a transmission opportunity from.

It will be appreciated that a frame transmission by a STA AC represents the successful outcome (i.e. a “win”) from a contention process involving one or more competing STA ACs, i.e. a STA AC has “won” a contention process by having its BC reach zero before the other competing STA ACs.

The process initially sets 151 a timestamp to be zero (reflecting the start of a measurement period). The next parsed frame is then taken from the buffer 54, from which its time information is obtained 153. Next, a check is performed to determine 154 if the parsed frame information indicates that the frame was one in which it had to contend and it is not corrupted. If not the interval data is simply updated 157 and if so it progresses to the steps involved in analyzing the contentions process:
1. Determine (estimate) 155 the composition of the contention process that resulted in the transmission by the STA AC. This involves the use of a Bayesian decision process to determine the composition of the contention process. Specifically this involves identifying the other STA ACs and their EDCA settings (or specifically the AC List Indices) that have participated in the contention process.
2. Determining 156 the average MAC contention parameters for the particular contention process. This involves the use of an ordered tree data structure as a lookup table to hold the average MAC parameters for the various combinations of competing EDCA settings.
3. Updating 157 the interval data which involves using the processed frame to update the channel data, its STA data and its STA AC data.
   After a specified measurement interval Tₘₑₐₛ has been determined to have elapsed 158, the MAC BW components for the measurement interval are calculated 159 for the channel, all active STAs and their STA ACs. This involves firstly calculating the average MAC contention parameters for each active STA AC for all its frame transmissions within the measurement interval.

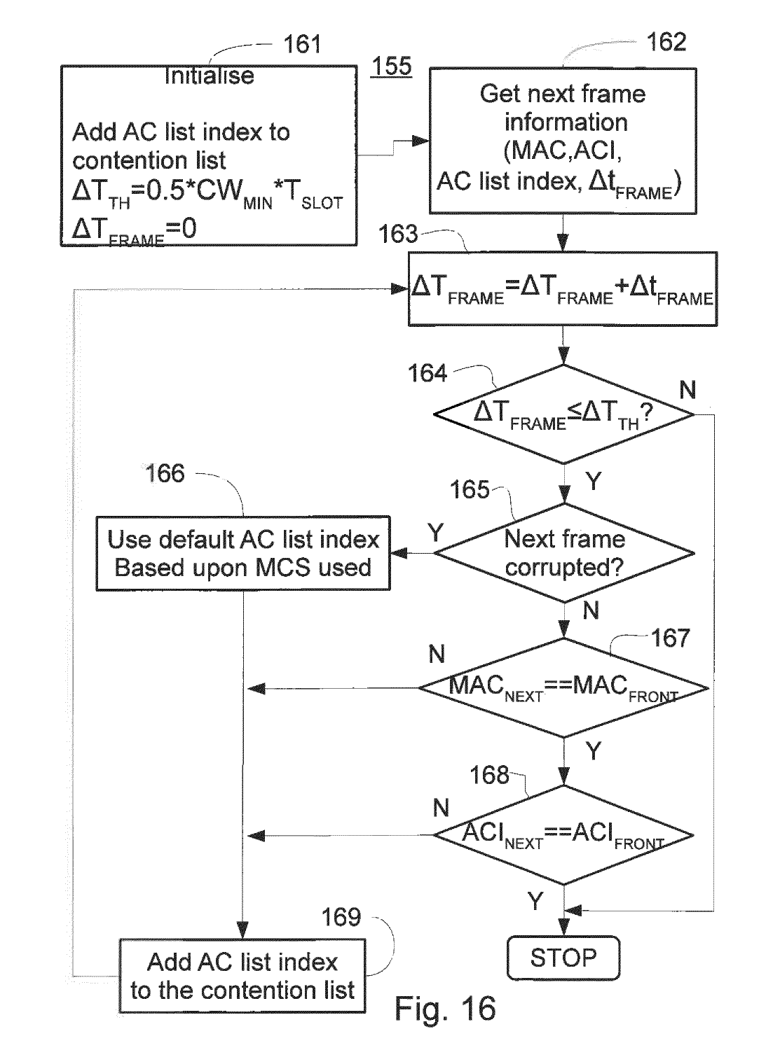

The flow chart in FIG. 16 illustrates an exemplary implementation of an exemplary Bayesian-based contention estimation algorithm. The objective of the process is to determine the composition of the contention process, i.e. to identify the competing MAC mechanisms (specified in terms of their EDCA settings or more precisely their AC list indices). The AC list indices of the competing STA ACs are collected into a Contention List.

The first step involves initializing 161 the process by adding the AC list index of the frame at the front on the Contention Process buffer to the Contention List. Next the threshold value ΔT_{TH} is calculated which is dependent on the CW value being used, i.e. given by CWmin which comes from the EDCA settings for the front frame.

ΔT_{TH}=½CWₘᵢₙ. (16)

Finally, the accumulated interframe interval time ΔT_{frame} is initialized to zero.

The interframe interval Δt_{frame} for the next frame in the Contention Process buffer is obtained 162 along with its MAC address, ACI and AC list index. The accumulated interframe interval time ΔT_{frame} is increased 163 by value of Δt_{frame} and is then compared 164 with the threshold value ΔT_{TH}. If ΔT_{TH}≦Δt_{frame} then the frame is deemed capable of having contended. However, it is necessary to establish if the frame has actually contended with the front frame.

First, it is necessary to determine 165 whether the frame is corrupted or not (obtained from the FCS flag in the Radiotap header). If the frame is corrupted then a default AC list index is used 166 (based upon the PHY used) is added 169 to the Contention List. If the frame is not corrupted, then its MAC address is compared 167 with that of the front frame. If the MAC addresses differ then different stations have been involved in the contention process and therefore its AC list index is added 169 to the Contention List. If the MAC addresses are the same, then the frame has come from the same station as the front frame, but it may have come from a different AC within the station. Therefore it is necessary to next compare 168 the ACIs. If they do not differ, then the Contention Process terminates as a STA AC cannot compete with itself. If the ACIs differ, then the frames have been transmitted from different STA ACs and therefore its AC list index is added 169 to the Contention List. After the Contention List has been updated, the process moves on examine the next frame in the Contention Process buffer. This continues until ΔT_{TH}>Δt_{frame}, where the process terminates.

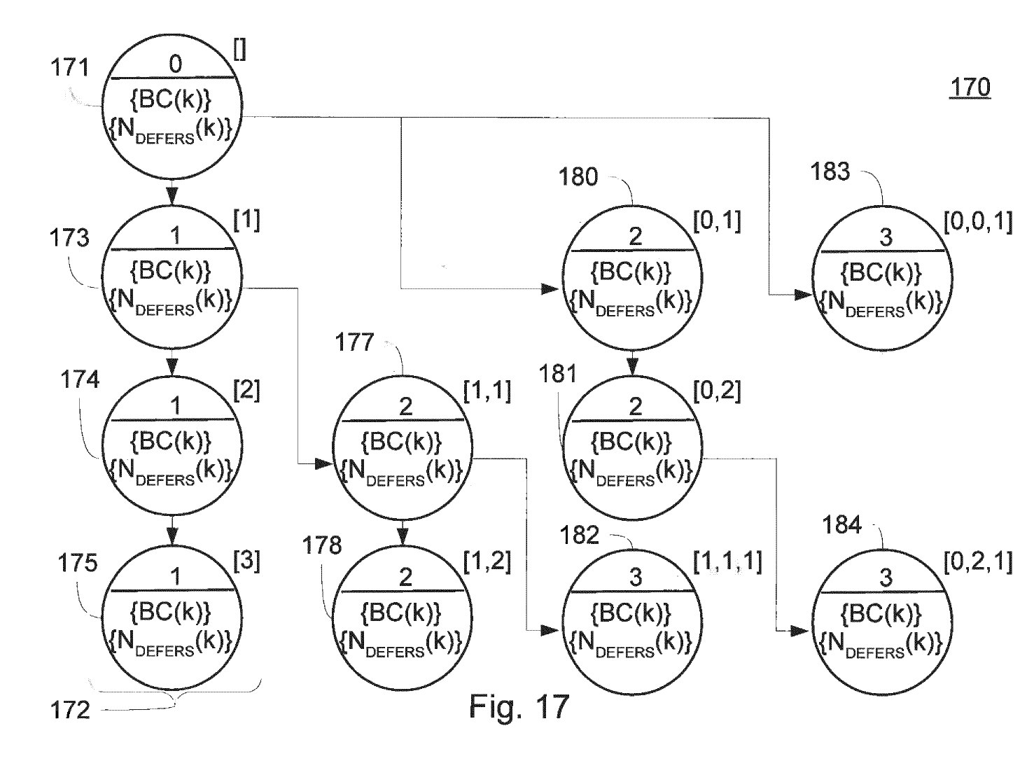

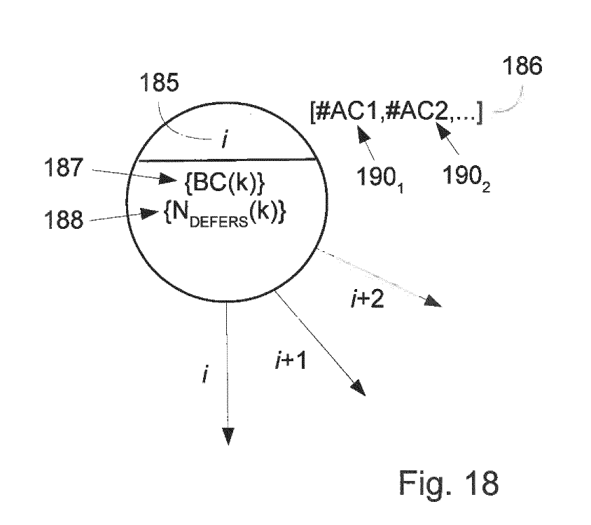

Having determined the composition of the contention process, i.e. having identified the STA ACs whose MAC mechanisms have participated in the contention interval of interest, the next step is to obtain the average MAC contention parameters for each of the competing STA ACs. This may be achieved through the use of a lookup table based upon an ordered tree data structure 170, for example as shown in FIG. 17, where each tree node holds the average MAC parameters (i.e. the average initial backoff counter value BC 187 and the average number of deferrals N_{defers} 188) experienced by each of the competing MAC mechanisms. An exemplary node is shown in FIG. 18, which is illustrative of the individual nodes 171, 173, 174, 175, 177, 178, 180, 181, 182, 183, 184 shown in the tree structure of FIG. 17. Each node is identified by the access category list index (i) 185 it is associated with and also by its position 186 in the tree. The root node 171 is an empty node, i.e not associated with any MAC mechanism. Whereas nodes 173, 174 and 175 represent as a group 172 nodes associated with a first access mechanism. More particularly, node 173 represents the case where there is a single MAC mechanism using the EDCA parameters, specified by the AC list index 1, competing for access. Node 174 corresponds to the case of two MAC mechanisms, each with a set of EDCA parameters specified by AC list index 1, competing for access. The node which is first in the branch for this first access medium represents the situation where there is just one station competing having that first access mechanism and is thus the number for #AC1 190₁ is designated as [1]. Similarly node 174 represents when two stations having that first access mechanism are competing as is thus represented as [2], similarly the number of stations for node 175 is shown as [3]. In contrast, node 177 which is the first node in a branch off node 173 having a second MAC mechanism 2 and so this node is identified by its place in the tree namely 1 node of the first AC and 1 node of the second, i.e. [1,1], or stated otherwise this node corresponds to the case where there are two MAC mechanisms competing for access, one MAC mechanism has a set of EDCA parameters specified by AC list index 1 and the MAC mechanism is specified by AC list index 2. Similarly, node 184 represents no station from the first AC, 2 from the second and one from the third and hence is identified as [0, 2, 1].

It is to be highlighted that the tree holds information on competing MAC mechanisms (not STAs or STA ACs per se) specified by their EDCA settings through the AC List Index. STAs or STA ACs will contain one or more competing MAC mechanisms, again specified by the AC List Index of the EDCA settings. In this way, the tree holds generic MAC contention information that can be used by any STA or STA AC that contends for access.

The values of the average MAC contention parameters at each tree node may be computed beforehand and loaded into the lookup tree at startup. Alternatively they can be computed on the fly as required thereby allowing the tree structure to grow naturally and become populated with the average MAC contention parameter values as they are required.

Suitably, the average MAC contention parameter values may be generated by using an IEEE 802.11 MAC mechanism simulator computer programme where each competing MAC mechanism is competing under saturation conditions, i.e. where each MAC mechanism is always competing for access. The simulator computes the average values of the initial counter value BC and the number of deferrals N_{defers} and records these values for each successful transmission by a MAC mechanism.

The data tree may be ordered in the sense that each node is the parent node to one or more child nodes whose AC List Index is greater than or equal to its own AC List Index. This ordering rule allows each node to represent a unique combination of competing MAC mechanisms. This allows for efficient searching and retrieval of the data stored in the tree. Moreover, it allows the tree to grow by adding new tree nodes as new combinations of competing MAC mechanisms are encountered. Each tree node address has the form [#_{AC1}, #_{AC2}, . . . ] where #_{AC1} represents the number of instances of a MAC whose EDCA parameters are described by the AC List Index 1. Similarly, #_{AC2} represents the number of instances of a MAC whose EDCA parameters are described by the AC List Index 2 etc.

For example, the tree node address [1,1] corresponds to a contention process involving 2 MAC mechanisms with AC List Indices 1 and 2 respectively. Similarly, the tree node address [0,2,1] corresponds to a contention process involving 3 MAC mechanisms: two of the MAC mechanisms have the EDCA settings corresponding to the AC List Index 2 and one MAC mechanism with the EDCA settings corresponding to the AC List Index 3.

The tree is ordered according to unique combinations of AC EDCA parameters (indexed by the AC List Index). So, for example, the set of EDCA parameters {2,4,10} will be indexed as 1, the set {2,5,10} indexed as 2, the set {2,3,10} indexed as 3 etc. The index is built on the fly—usually in the order of when the EDCA settings were first encountered (generated from the parsing of the beacon management frames). The actual assignment is not important, only that the ordering and assignment is maintained consistently.

For example, if the Bayesian analysis determined that the front frame from STA A with an AC List index=1 has contended once with another station STA B with an AC list index=3, then the node address for this particular contention process (between these two EDCA settings) in the tree structure would be (1,0,1). Similarly, if the front frame had contended twice with STA B, the corresponding tree address would be (1,0,2).

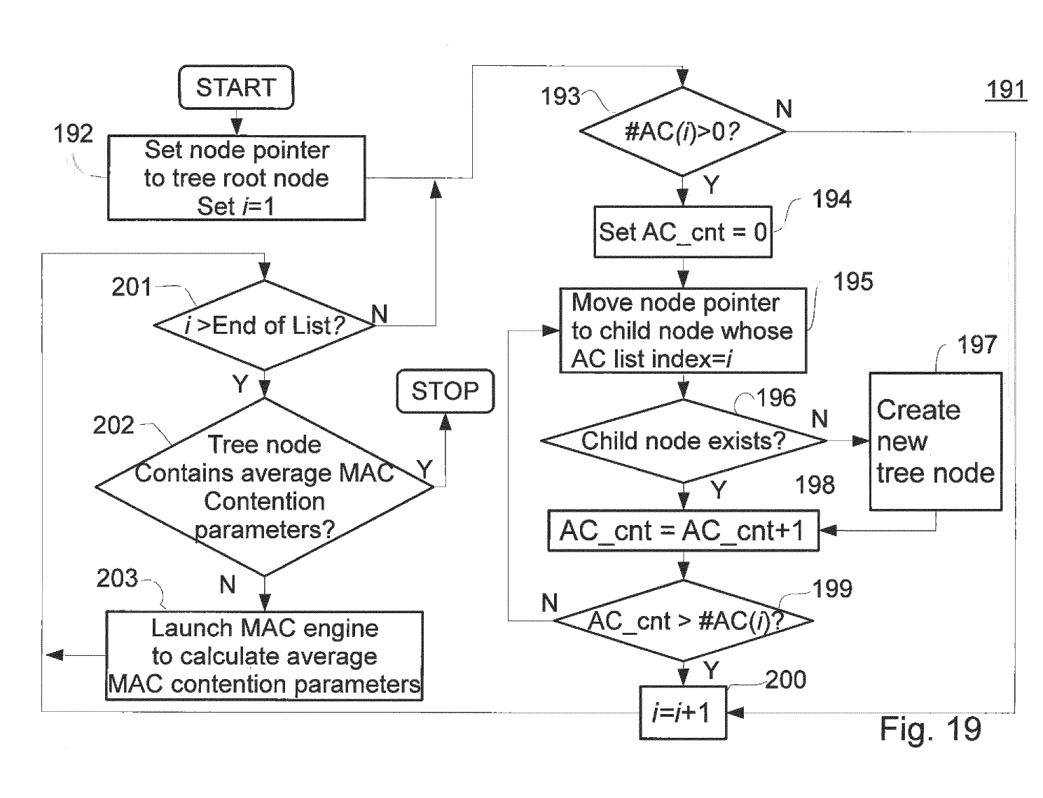

The Contention List generated by the Bayesian Contention Estimation process may be parsed to determine the tree node holding the average MAC contention parameters. An exemplary process 191 is illustrated in FIG. 19. The Contention List is used to direct the movement of a tree node pointer to the relevant tree node. The tree node pointer is initially set 192 to the tree root node and is moved to the appropriate child node as indicated by the #_{AC} settings of the Contention List.

Thus it checks 193 if there is an i^{th} AC present, if not it increments 200 i to the next value. Where there is an i^{th} AC present, a counter is set to zero and then node pointer is incremented. If any child node is found 196 not to exist, then a new tree node is created 197. It then progresses until all of the nodes for the AC have been counted 199. Whereupon, it moves to the next AC in the branch. When the contents of the Contention List have been fully processed 201 the tree node pointer will point to the required tree node. If the tree node contains 202 a set of average MAC contention parameters the process terminates. If not, a MAC engine is launched 203 that executes a computer simulator program that calculates the parameters and stores them at the tree node.

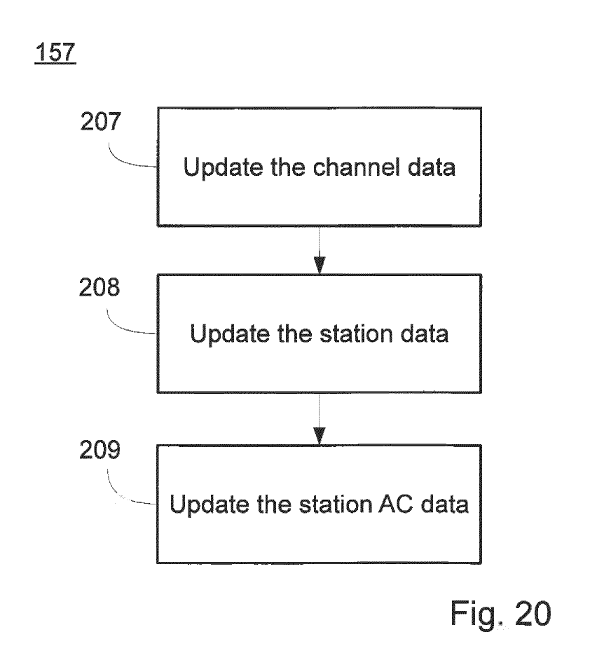

Updating 157 the interval data involves updating channel data 207, updating STA data 208 and updating STA AC data 209 as shown in FIG. 20.

In the case of the channel data this involves updating the medium busy time T_{busy} where

$${T}_{busy} = {\sum }_{1} {T}_{busy}^{( 0} \qquad ( 17 )$$

Where T_{busy}^{(t)} is the duration of the i^{th} busy interval.

In the case of STA k, this involves updating the time associated with the transmission of it load T_{load}(k)

$${T}_{load} ( k ) = {\sum }_{1} {T}_{load}^{( i )} ( k ) \qquad ( 18 )$$

Where T_{load}^{(t)}(k) is the duration of the i^{th} frame transmission from STA k.

The access time T_{access}(k) has two components: the time spent deferring N_{defers} and the time spent backing off which depends on the initial backoff counter value BCᵢₙᵢₜᵢₐₗ. A STA AC's MAC mechanism may experience several intervals of deferral which is dependent on a number of factors, e.g. the number of other STA ACs contending for accessing the medium, its own initial backoff counter value and the other STA ACs' initial backoff counter values. As these two time intervals are random, so it makes sense to consider them in terms of their average values N̅_{defers} and B̅C̅ᵢₙᵢₜᵢₐₗ respectively.

After a predetermined time interval has been calculated 158 to have elapsed, the MAC BW Components may be calculated 159 for the interval.

Each active STA AC within the measurement interval maintains a record of its frame transmissions. Specifically this involves maintaining a record of its average MAC contention parameters N_{defers}(t) and BCᵢₙᵢₜᵢₐₗ(t) for its successful contention processes, i.e. those contention processes that resulted in a transmission for the STA AC.

At the end of the measurement interval each competing STA AC computes its average MAC contention parameters N̅_{defers} and B̅C̅ᵢₙᵢₜᵢₐₗ for the measurement interval, i.e.

$$\begin{matrix}{\overline{N}}_{defers} = \frac{1}{{N}_{TX}} {\sum }_{t = 1}^{{N}_{TX}} {N}_{defers} ( i ) \\ And & ( 19 ) \\ {\overline{BC}}_{initial} = \frac{1}{{N}_{TX}} {\sum }_{t = 1}^{{N}_{TX}} {BC}_{initial} ( i ) & ( 20 )\end{matrix}$$

where N_{TX} is the number of transmissions by the STA AC within the measurement interval.

The average MAC contention parameters N̅_{defers} and BCᵢₙᵢₜᵢₐₗ for the measurement interval may used to compute the average access time T̅_{access} for the STA AC using the following equation:

T̅_{access}=T̅_{defer}+T̅_{backoff} (21)

Where the average deferral time T̅_{defer} is given by

T̅_{defer}=N̅_{defer}×T_{AIFS} (22)

And the average backoff time T̅_{backoff} is given by

T_{backoff}=BC×Tₛₗₒₜ (23)

Where T_{AIFS} is the deferral time given by

T_{AIFS}=T_{SIFS}+AIFSN×Tₛₗₒₜ (24)

Where T_{SIFS} is the Short Inter-frame Spacing and Tₛₗₒₜ is the duration of a time slot. The values of these two parameters are defined for the PHY used and are specified in the IEEE 802.11 standards.

The average access time is multiplied by the total numbers of frames transmitted in the T̅_{access} measurement interval of interest N_{TX} is the access time interval T_{access} which is given as follows:

T_{access}=T̅_{access}×N_{TX} (25)

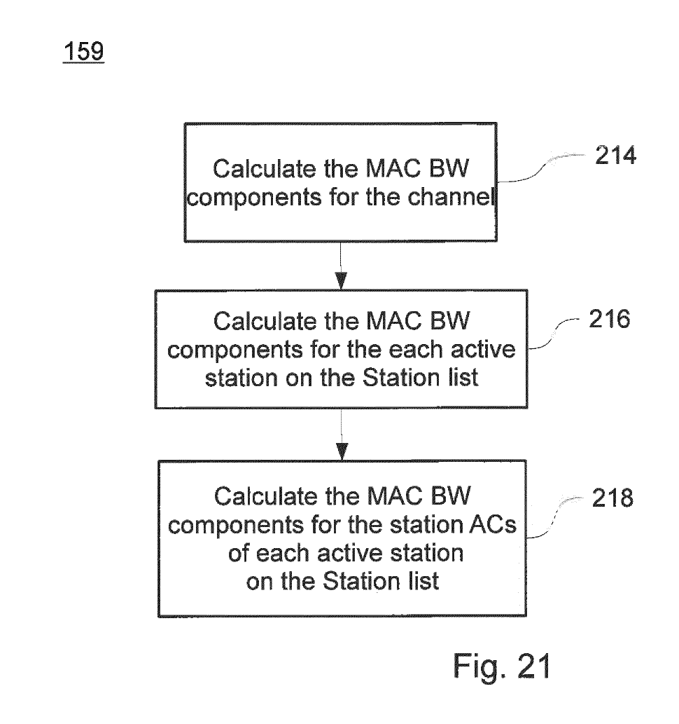

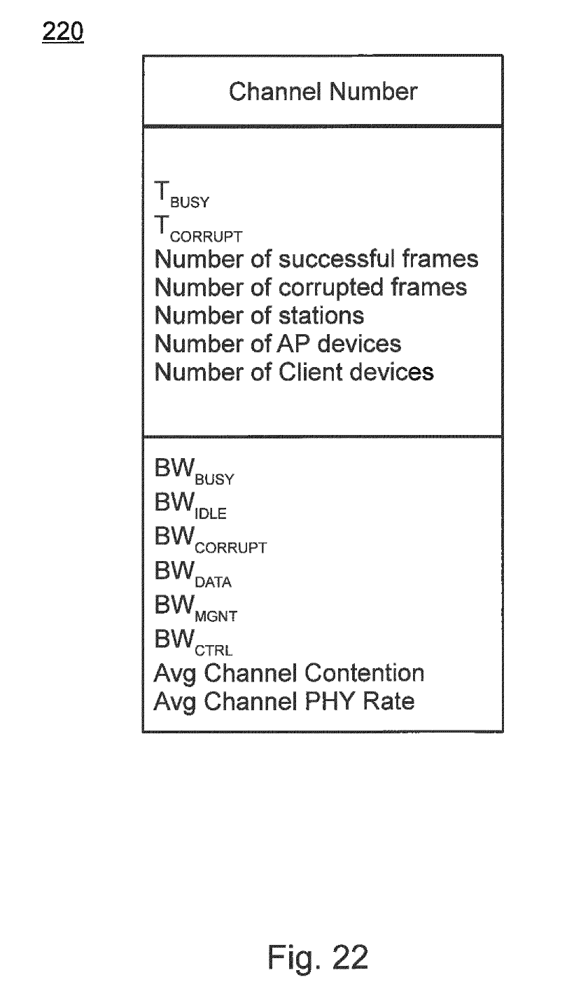

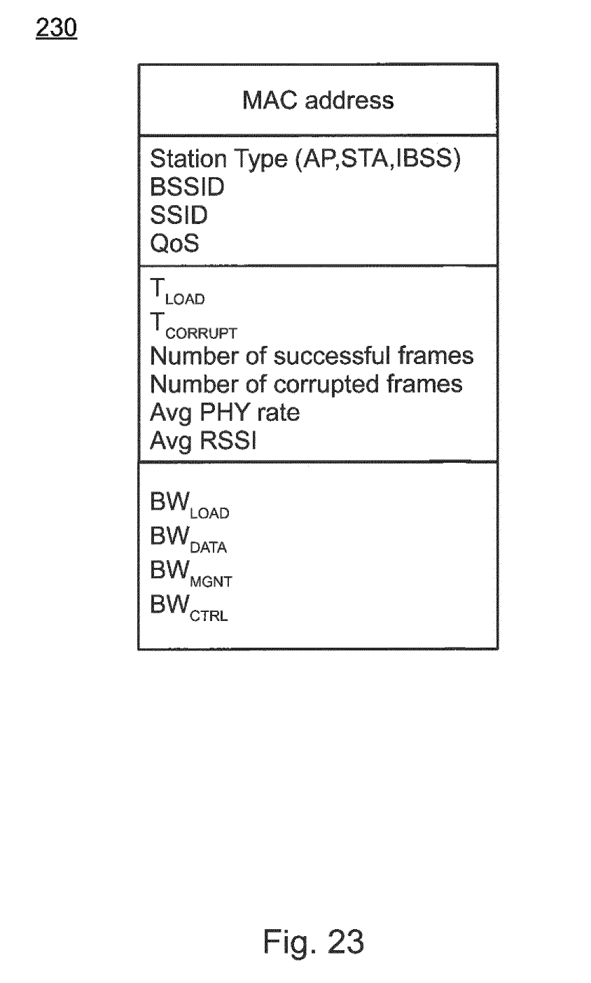

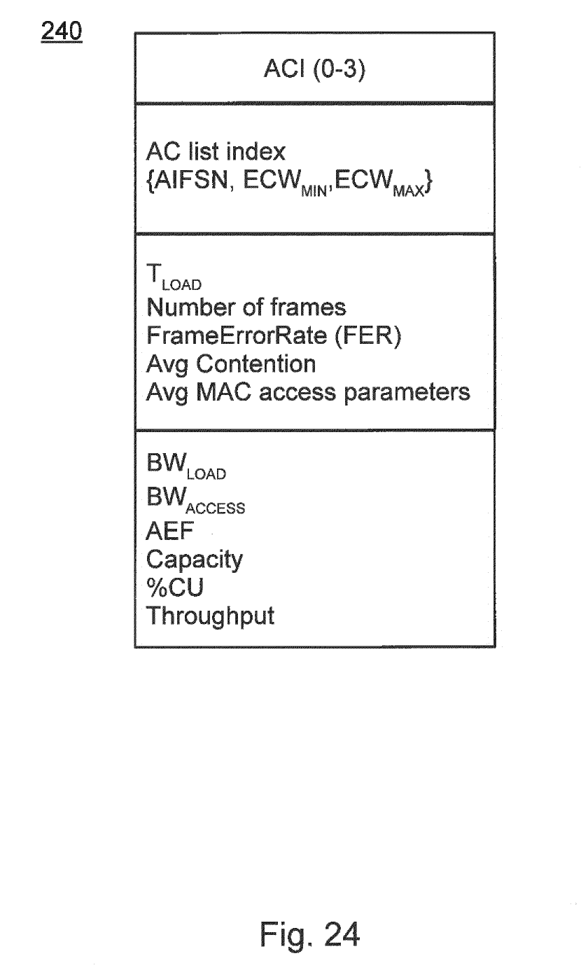

Once all the time components have been calculated and estimated for the measurement interval, the final step is to: calculate 214 the MAC BW components 220 for the channel along with potentially other data which may be readily calculated from the measurements (shown in FIG. 22), calculate 216 the MAC BW components 230 (shown in FIG. 23) for the STAs and calculate 218 the MAC BW components 240 (shown in FIG. 24) for the STA ACs using the process as shown generally in FIG. 21.

The conversion of a time component to a MAC BW component involves normalizing it. The process of normalizing involves dividing its duration Tₓ by the duration of the measurement interval Tₘₑₐₛ using:

$${BW}_{x} = \frac{{T}_{x}}{{T}_{meas}} \qquad ( 26 )$$

For example, the BW_{busy} component is given by

$${BW}_{busy} = \frac{{T}_{busy}}{{T}_{meas}} \qquad ( 27 )$$

Similarly, the BW_{load}(k) and BW_{access}(k) for a STA or STA AC k is given by

$$\begin{matrix}{BW}_{load} ( k ) = \frac{{T}_{load} ( k )}{{T}_{meas}} \\ And & ( 28 ) \\ {BW}_{access} ( k ) = \frac{{T}_{access} ( k )}{{T}_{meas}} & ( 29 )\end{matrix}$$

The Access Efficiency Factor (AEF) for a STA or STA AC k is given by

$$AEF ( k ) = \frac{{BW}_{load} ( k )}{{BW}_{load} ( k ) + {BW}_{access} ( k )} \qquad ( 30 )$$

Once measurements have been obtained and these values calculated for the performance of the network and in particular the AEF for each station/station AC, the resulting values may be employed to perform a control function generally within the network, either at the AP or within individual stations.

In one exemplary arrangement, the measurements are employed by a WLAN bandwidth controller.

The WLAN bandwidth controller suitably uses two inputs, the locally measured AEF values and the target capacities specified by the user/network administrator. From these, the bandwidth controller calculates a set of target AEFs, i.e. {AEF^{T}}_{AC} for each of the ACs within the QAP. The calculation of the AEF allows for the calculation of bandwidth availability. The process comprises the steps of calculating the AEF of every STA and every STA AC on the channel. In this respect, the channel will be appreciated to be the channel as detected by the controller, i.e. within the reception range of the measurement part 24 of controller box. These AEFs then allow the bandwidth availability to be calculated for every STA and STA AC including the QAP ACs. By comparing the actual AEFs measured for the STA ACs with those required, the values of the target AEFs can be calculated.

A tuning algorithm 26 suitably then determines what tuning actions need to be taken (within the feedback control loop) to force the actual AEF values to converge to the target AEF values.

The tuning algorithm suitably tunes the EDCA settings {AIFSN, ECWmin, ECWmax}_{AC} to operate in such a way that the respective AEF values converge to those of the target AEFs, i.e. AEF_{AC}→AEF_{AC}^{T} for each AC within the QAP. Thus the EDCA settings for each STA AC may be adjusted and the response to the adjustment measured by the feedback loop.
One the major obstacles hindering the widespread use of the IEEE 802.11e QoS facility is a generally poor understanding of how to configure the EDCA parameter settings.
Firstly, there are too many of them, three for each of the four ACs which makes a total of 12 parameters that need to be set by a user for each QAP.
A further problem associated with setting the EDCA parameter values is that it is not possible to tune them individually for each AC in isolation from the other ACs, since adjusting one will have an effect on the other ACs.
Also, the default values specified in the standard are of limited use since their effectiveness (or otherwise) is to a large extent determined by the nature of the network load. All of which makes it extremely challenging to implement effective radio resource management on IEEE 802.11e/WMM networks.
Additionally, it will be appreciated that network loads can vary significantly and thus selected values may be ideal under certain operating conditions but may be far from ideal under other network load conditions.

WLAN Bandwidth Controller

The WLAN bandwidth controller, described above, removes all these practical obstacles by replacing the need to specify the individual EDCA values with the specification of a set of maximum permissible capacity utilization limits for each of the access categories {CUₘₐₓ}_{AC}. Indeed, these need not necessarily be specified but could instead be selected as a default set by a user. Similarly, a user could select a set from a list of sets indicative of different types of network or operating desires.

As a result, the only user input required is to choose or specify a set of maximum permissible capacity utilization limits for each of the access categories {CUₘₐₓ}_{AC}. As a result, the user avoids having to deal directly with configuring the EDCA parameter settings. Moreover, the user never has to worry about the changing nature of the network load, since the WLAN bandwidth controller automatically makes the necessary adjustments to the EDCA parameter settings in an effort to ensure that the maximum capacity utilization limits are never exceeded.

Essentially, the WLAN bandwidth controller measures the capacity utilization (CU) of the QAP. The measured CU for each of the ACs of the QAP is compared with a maximum CU value specified by the user/network manager. Suitably, if the measured CU for an AC exceeds the maximum value specified, then the EDCA parameters for that AC are adjusted to bring the CU below this maximum value. In effect, the WLAN bandwidth controller implements what will be understood as a classic feedback approach whereby a feedback loop controlled by an EDCA tuning algorithm which is placed around the QAP as shown in FIG. 2.
The basic strategy employed by the bandwidth controller is to specify a maximum capacity utilization CUₘₐₓ for each AC and then to tune the EDCA parameters in such a way as to ensure that these maximum values are not exceeded. The WLAN bandwidth controller is used to provide real-time measurements of the capacity utilizations {CU}_{AC} for each of the AC streams. These {CU}_{AC} measurements provide one of the inputs to the Tuning Algorithm, the other input being the maximum capacity utilization specified for each AC, i.e. {CUₘₐₓ}_{AC}. The Tuning Algorithm then determines updated EDCA settings required for each AC, i.e. {AIFSN, ECWₘᵢₙ, ECWₘₐₓ}_{AC} which are then applied to the QAP.
It will be appreciated that there may also be other traffic streams present where it may not be possible to control the EDCA parameters, e.g. traffic from non-QoS enabled stations and stations not associated with the QAP in question. Accordingly, the Tuning Algorithm may include this external traffic in its calculations of the new EDCA parameters.

### Tuning Algorithm

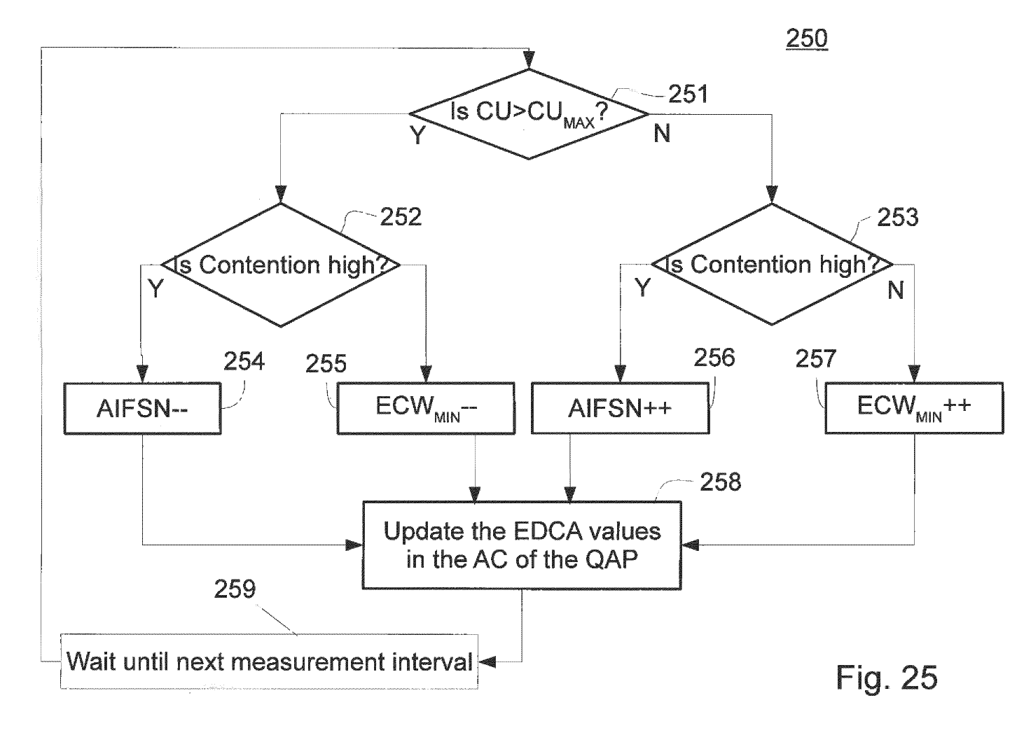

It will be appreciated that a variety of different tuning algorithms may be usefully employed to determine\adjust the EDCA settings.
However, owing to the complexity of the relationship between the EDCA parameters and the resulting {AEF}_{AC} values (and hence the {CU}_{AC} values), certain approaches may be more appropriate. Thus, in the exemplary implementation which is now described a heuristic approach to the development of the Tuning Algorithm was adopted.
The heuristic Tuning Algorithm 250 shown in FIG. 25 is based upon making incremental adjustments to the values of the AIFSN and ECWₘᵢₙ parameters at each time step, i.e. every Tₘₑₐₛ seconds. After each measurement interval Tₘₑₐₛ when a set of new performance metrics has been generated 259 by the WLAN Controller, the Tuning Algorithm determines whether to increase 256 or decrease 254 the value of the AIFSN or whether to increase 257 or decrease 255 the value of ECWₘᵢₙ parameter for each AC of the QAP in turn. These changes are then sent 258 to the QAP and the algorithm waits until the next set of new performance metrics arrives.
It will be appreciated that the tuning algorithm may elect not to tune all of the ECDA parameters.
More particularly, it will be noticed that no mention has been made of the Tuning Algorithm tuning the ECWₘₐₓ (or the TXOP) parameters. The reason for this is that it has been determined that the impact on performance is relatively insignificant compared to that for the AIFSN and ECWₘᵢₙ parameters. Accordingly, in this implementation efficiency in design and operation of the tuning algorithm is selected over perfection in all determining all parameters. However, other approaches are possible. For example, the value of ECWₘₐₓ may be tuned in an outer control loop which responds slower to network conditions.
In the exemplary implementation, the design of the Tuning Algorithm was based upon some general rules or assumptions, which may be stated as follows:
Decreasing the value of the AIFSN parameter causes the CU to decrease (and vice versa).
Decreasing the value of the ECWₘᵢₙ parameter causes the CU to decrease (and vice versa).
Under high contention levels, the AIFSN parameter is the more effective EDCA parameter in controlling the CU.
Under low contention levels, the ECWₘᵢₙ parameter is the more effective EDCA parameter in controlling the CU.
   As a result of which corresponding comparison steps 251, 252 and 253 are employed in the process of FIG. 25.
   As the performances of the ACs are coupled via the shared contention for access, changing the EDCA parameters of one AC will have an impact on the performances of the other ACs. Consequently, it is necessary to update the EDCA parameters of all the ACs at each time step.
   Under the action of the feedback loop, the Tuning Algorithm will converge to a set of EDCA parameter settings that will satisfy the maximum CU limits specified by the user/network operator.
   These EDCA parameters may then be communicated to the AP to update 258 the AP settings for the network as previously discussed above.

Whilst the present application has been described generally with reference to performing measurements with respect to the AP for the purposes of optimizing the ECDA settings on the AP, other applications are possible. Thus for example, a series of measurements may be performed by any STA to determine available capacity from the STA perspective rather than the AP perspective. This determination could be used by the STA in several different applications. For example, it might be used to select between two or more available AP's based on the capacity measured for the STA for each AP. In contrast, existing methods might simply make this selection based on received signal strength (RSSI). This may be particularly useful in a large building or space where there are several access points available to gain access to the same network, for example as might be found in an office, hotel, conference space or airport. Using the methods above, a user device could determine which of a plurality of access points has most capacity available and establish a connection on that basis. Similarly, a user device could periodically or continuously make determinations on availability and switch between available access points based on the determination.

Similarly, it might be used in a comparison with other wireless/wired connections, to determine different modes of access based on capacity.

As an example, one application would be is mobile telephone devices with Wi-Fi capability. In such mobile devices, there is frequently a choice of data channel, i.e. Wi-Fi connection, or cellular wireless connection (e.g. GPRS, 3G, 4G). Generally, the devices default to a Wi-Fi connection on the premise that these connections are free. However, it will be appreciated that using a measurement of capacity, a user can make a determination based on performance. Such functionality may readily be implemented with a decision made to switch between modes depending on the measured capacity of Wi-Fi.

Indeed, one specific example of such an approach would be in the context of ANDSF (access network discovery and selection function). This functionality allows a handset to automatically (and optimally) decide when to handoff between a wireless telephone (e.g. 3G) network and a Wi-Fi hotspot.

Virtually all ANDSF solutions to date use the signal strength (RSSI) as the trigger metric, i.e. when the W-Fi signal gets above a certain threshold value, it triggers a handoff to the Wi-Fi network.

Whilst this appears reasonable, it is clearly not related to capacity. Handing over a user to Wi-Fi where there is no available capacity (albeit signal strength) may lead to significant customer frustration levels.

However, by performing a measurement of capacity at a wireless device, i.e. the ability of the Wi-Fi network (AP) to carry the required data a better measure is presented to determine when and if to switch between the wireless cellular telephone network and Wi-Fi. Similarly, it may be used to determine when to switch back again. Whilst such capacity may be measured using the techniques described above, other techniques may be used. For example, those described in U.S. Pat. No. 7,664,031 may equally be employed.

The words comprises/comprising when used in this specification are to specify the presence of stated features, integers, steps or components but does not preclude the presence or addition of one or more other features, integers, steps, components or groups thereof.

1. A device for updating EDCA parameters in a Wireless local area network (WLAN) comprising a plurality of wireless stations including an access point, the device comprising:
a wireless interface for receiving packets broadcast on the wireless medium of the WLAN;
an analyser for analysing the received packets to determine capacity utilization values for individual classes of traffic broadcasting on the wireless medium, where the capacity utilization value represents how close to saturation that class of traffic is on the medium;
a controller responsive to the determined capacity utilization values for each class of traffic and being configured to provide at least one updated EDCA value to the access point.

2. The device according to claim 1, wherein the at least one updated EDCA parameter comprises an AIFSN value, a ECWₘᵢₙ value or both.

3. The device according to claim 1, wherein the capacity utilization values are in turn calculated from access efficiency values (AEF) which are given by
$$AEF ( k ) = \frac{{BW}_{load} ( k )}{{BW}_{load} ( k ) + {BW}_{access} ( k )}$$
where k represents a STA AC and BW_{load} represents a measure of the data being successfully transmitted and BW_{access} represents a relative measure of the time required to gain access to the wireless medium for that data.

4. The device according to claim 3, wherein the capacity utilization value of a −station i, C(i), is defined as
C(i)=AEF(i)[1−Σ_{j≠i}BW_{load}(j)]

5. The device according to claim 1, wherein the device is integrated within the access point.

6. The device according to claim 1, further comprising a communications interface for communicating the at least one updated EDCA value from the device to the access point.

7. The device according to claim 6, wherein the communications interface communicates the updated EDCA values to the access point through a Telnet, SSH session or using SNMP.

8. The device according to claim 3, wherein the analyser is configured to estimate the average contention being experienced by the MAC mechanism for that class k in contending for access to the medium and to employ this to determine BW_{access} value for that class.

9. The device according to claim 8, wherein the analyser is configured to perform the estimation of the average access time using a contention chain data structure to capture the statistics of the medium interframe times by reference to the contention present on the wireless channel.

10. The device according to claim 9, wherein the analyser is configured to employ a decision process to assess the interframe time for the channel to determine the extent of the contention.

11. The device according to claim 10, wherein the decision process is a Bayesian based process.

12. The device according to claim 10, wherein the analyser is configured to construct a tree data structure to contain contention values and where the analyser is configured to employ the tree data structure to process the medium inter-frame transmission times of contending stations subject to the EDCA values being updated.

13. The device according to claim 12, wherein the analyser is configured to employ a mathematical model based on the MAC access mechanism of the MAC framework of the wireless channel to produce the average access time values from which the access efficiency factors may be determined.

14. A wireless device comprising:
a first wireless interface for transmitting and receiving data over a first wireless network, where the first wireless network is a WLAN;
a second wireless interface for transmitting and receiving data over a second wireless network;
a measurement interface for measuring the bandwidth available for the wireless device to transmit data on the first wireless network before saturation occurs; and
wherein the wireless device is configured to determine whether to use the first or the second wireless function based on said capacity measurement of the available bandwidth.

15. The wireless device according to claim 14, wherein the second wireless interface is a mobile telephone interface, for example GSM, GPRS, 3G or 4G.

16. A wireless device comprising:
a wireless interface for transmitting and receiving data over a WLAN; a measurement interface for performing measurements on frames captured by the wireless interface;
an analyser for determining the presence of two or more access points on the WLAN and calculating the bandwidth available for the wireless device to transmit data to each of said access points before saturation occurs and whereupon the wireless device is configured to select an access point to connect to based upon said calculation.

17. A system for updating EDCA parameters in a Wireless local area network (WLAN) comprising an access point, the system comprising: a wireless device comprising a wireless interface for receiving packets broadcast on the wireless medium of the WLAN;
the wireless device being configured to parse the received packets to obtain parsed data for the packets;
the wireless device being configured to transmit the parsed data to a server;
the server being configured to analyse the parsed data to determine capacity utilization values for individual classes of traffic broadcasting on the wireless medium, where the capacity utilization value represents how close to saturation that class of traffic is on the medium;
wherein the server is configured to provide at least one updated EDCA value to the access point in response to the determined capacity utilization values.

18. The system according to claim 17, wherein the parsed data comprises the following information for received packets:
a frame timestamp;
a Frame Check Sum (FCS), the Modulation and Coding Scheme (MCS) and captured frame size.

19. The system according to claim 18, wherein the parsed data further comprises an identification of frame type,
one or more MAC address, and
an access category index.

20. The system according to claim 17, wherein the parsed data omits the data payload of the packet.

21. The system according to claim 17, wherein the wireless device is the access point.

22. The system according to claim 17, wherein the server is not on the WLAN.
